(19) United States
(12) Patent Application Publication
(10) Pub. No.: US 2018/0143802 A1
(43) Pub. Date: May 24, 2018

(54) METHOD FOR PROCESSING VARIOUS INPUTS, AND ELECTRONIC DEVICE AND SERVER FOR THE SAME

(71) Applicant: SAMSUNG ELECTRONICS CO., LTD., Suwon-si (KR)

(72) Inventor: Sung Woon JANG, Hwaseong-si (KR)

(21) Appl. No.: 15/817,651

(22) Filed: Nov. 20, 2017

(30) Foreign Application Priority Data
Nov. 24, 2016 (KR) 10-2016-0157498

(51) Int. Cl. G06F 3/16; G06F 3/0481; G06F 3/0482; G10L 15/22; G10L 15/18; G10L 15/30

(52) U.S. Cl. CPC G06F 3/167; G06F 3/04817; G10L 15/30; G10L 15/22; G10L 15/1815; G06F 3/0482

(57) ABSTRACT

Disclosed is an electronic device. The electronic device includes a memory and at least one processor. The processor is configured to obtain a first input, determine first information on the basis of the first input and a first domain matching the first input, obtain a second input following the first input, determine second information based on the second input and the first domain in response to the second input, and determine third information based on the second input and a second domain different from the first domain.

### CROSS-REFERENCE TO RELATED APPLICATION

This application is based on and claims priority under 35 U.S.C. § 119 to a Korean patent application filed on Nov. 24, 2016 in the Korean Intellectual Property Office and assigned Serial number 10-2016-0157498, the disclosure of which is incorporated by reference herein in its entirety.

### TECHNICAL FIELD

The present disclosure relates generally to a technology for recognizing a user input and executing an instruction using various input recognition models (e.g., a speech recognition model) equipped in an electronic device or a server.

### BACKGROUND

Modern electronic devices may support a variety of input methods, such as speech input, in addition to conventional input methods using a keyboard or a mouse. For example, electronic devices, such as smartphones or tablet computers, may recognize a user's speech that is input in the state in which a speech recognition service is executed, and may perform an operation corresponding to the speech input or may provide a search result.

Recent speech recognition services may be configured on the basis of natural language processing technology. The natural language processing technology is a technology for determining intent of a user's speech (or utterance) and providing a result corresponding to the intent to the user. In the case where it is difficult to determine the user's intent with only the speech that is input to determine the user's intent, an additional input or information may be used.

### SUMMARY

In the case where information is not sufficient to determine a user's intent through the user's speech, an electronic device may determine the user's intent on the basis of a previous dialog history and may provide an appropriate result. According to an embodiment, even if the user utters only the name of a region or a date after uttering the subject of today's weather, the electronic device may derive an appropriate result by recognizing intent to search for the weather. For example, in the case where the user provides an inquiry “What is the weather today?” through a microphone of the electronic device, the electronic device may provide an answer “The weather in the current position is fine.” In the case where the user successively utters “Busan”, the electronic device may provide an answer “Busan will be cloudy with rain today”, considering that the subject of the previous speech is “today's weather”. Although the electronic device provides an appropriate result by performing natural language processing on the basis of previous dialog histories if an input element is changed within a predetermined range (e.g., time, category, or the like) from the previous dialog histories, the electronic device may fail to provide an appropriate result for an inquiry that does not match the previous dialog histories. In the case where the electronic device fails to find intent matching a current speech despite reference to a previous dialog history (e.g., a dialog history right before the speech), or in the case where a previous dialog history or the best dialog history is not in accordance with the user's intent, the electronic device has to receive additional information from the user.

For example, after the user obtains a weather result for an inquiry “What is the weather today?” through the microphone of the electronic device, the user may receive a search result for an inquiry “Let me know famous restaurants in Busan” through a screen. Thereafter, if the user utters “Everland”, the electronic device may provide a search result for famous restaurants around Everland with reference to the previous dialog, or may provide an additional inquiry “What do you want to know about Everland?”

In the case where the user wants to search for the weather in Everland, the user may have to utter an entire inquiry “What is the weather in Everland today?”, or may have to utter an answer to the foregoing additional inquiry.

Aspects of the present disclosure address at least the above-mentioned problems and/or disadvantages and provide at least the advantages described below. Accordingly, an example aspect of the present disclosure is to provide an input processing method for improving inefficiency that may occur in the aforementioned situations and easily and rapidly provide information that a user wants, based on one or more user inputs (e.g., speech recognition and/or a gesture).

In accordance with an example aspect of the present disclosure, an electronic device includes a memory and at least one processor. The at least one processor may be configured to obtain a first input, to determine first information based on the first input and a first domain matching the first input, to obtain a second input following the first input, to determine second information based on the second input and the first domain in response to the second input, and to determine third information based on the second input and a second domain different from the first domain.

In accordance with another example aspect of the present disclosure, a server includes storage, a communication circuit configured to receive a plurality of inputs from an electronic device, and at least one processor. The at least one processor may be configured to determine whether a first input, among the plurality of inputs, matches a first domain, to determine whether the first input matches a second domain different from the first domain, and to transmit information about the first domain and information about the second domain to the electronic device, based on a matching determination with the first domain and second domain.

In accordance with another example aspect of the present disclosure, a method includes obtaining a first input, outputting first information on a display in response to the first input, obtaining a second input following the first input, and outputting second information and third information on the display in response to the second input.

According to various example embodiments of the present disclosure, recognition of an input may be performed based on one or more user inputs (e.g., speech recognition and/or a gesture), and desired information may be easily and rapidly provided by using a recognition result and an existing dialog history.

According to various example embodiments of the present disclosure, a user may simply utter only desired contents on the basis of a previous recognition result, and thus usability of speech recognition may be improved. In addition, the present disclosure may provide various effects that are directly or indirectly recognized.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and attendant advantages of the present disclosure will be more apparent and readily appreciated from the following detailed description, taken in conjunction with the accompanying drawings, in which like reference numerals refer to like elements, and wherein:

FIG. 1 is a diagram illustrating an example electronic device and an example server connected with the electronic device through a network, according to an example embodiment of the present disclosure;

FIG. 2 is a diagram illustrating an example electronic device and an example server, according to another example embodiment of the present disclosure;

FIG. 3 is a diagram illustrating an example correlation between a domain, intents, and slots, according to various example embodiments of the present disclosure;

FIG. 4 is a flowchart illustrating an example input processing method according to an example embodiment of the present disclosure;

FIG. 5 is a diagram illustrating an example user interface displayed on an electronic device, according to an example embodiment of the present disclosure;

FIG. 6 is a flowchart illustrating an example input processing method according to another example embodiment of the present disclosure;

FIG. 7 is a flowchart illustrating an example input processing method according to another example embodiment of the present disclosure;

FIG. 8 is a diagram illustrating an example user interface displayed on an electronic device, according to another example embodiment of the present disclosure;

FIG. 9 is a diagram illustrating an example user interface displayed on an electronic device, according to another example embodiment of the present disclosure;

FIG. 10 is a flowchart illustrating an example input processing method according to another example embodiment of the present disclosure;

FIG. 11 is a flowchart illustrating an example input processing method according to another example embodiment of the present disclosure;

FIG. 12 is a diagram illustrating an example user interface displayed on an electronic device, according to another example embodiment of the present disclosure;

FIG. 13 is a diagram illustrating an example user interface displayed on an electronic device, according to another example embodiment of the present disclosure;

FIG. 14 is a flowchart illustrating an example input processing method according to another example embodiment of the present disclosure;

FIG. 15 is a diagram illustrating an example user interface displayed on an electronic device, according to another example embodiment of the present disclosure;

FIG. 16 is a diagram illustrating an example electronic device in a network environment, according to an example embodiment of the present disclosure;

FIG. 17 is a block diagram illustrating an example electronic device, according to an example embodiment of the present disclosure; and

FIG. 18 is a block diagram illustrating an example program module, according to an example embodiment of the present disclosure.

Throughout the drawings, it should be noted that like reference numbers are used to depict the same or similar elements, features, and structures.

### DETAILED DESCRIPTION

Hereinafter, various example embodiments of the present disclosure may be described with reference to accompanying drawings. Accordingly, those of ordinary skill in the art will recognize that modifications, equivalents, and/or alternatives of the various example embodiments described herein can be variously made without departing from the scope and spirit of the present disclosure. With regard to description of drawings, similar elements may be marked by similar reference numerals.

In this disclosure, the expressions “have”, “may have”, “include” and “comprise”, or “may include” and “may comprise” used herein indicate existence of corresponding features (e.g., elements such as numeric values, functions, operations, or components) but do not exclude presence of additional features.

In this disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used in this disclosure may be used to refer to various elements regardless of the order and/or the priority and to distinguish the relevant elements from other elements, but do not limit the elements. For example, “a first user device” and “a second user device” indicate different user devices regardless of the order or priority. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. On the other hand, when an element (e.g., a first element) is referred to as being “directly coupled with/to” or “directly connected to” another element (e.g., a second element), it should be understood that there is no intervening element (e.g., a third element).

According to the situation, the expression “configured to” used in this disclosure may be used interchangeably with, for example, the expression “suitable for”, “having the capacity to”, “designed to”, “adapted to”, “made to”, or “capable of”. The term “configured to” does not refer only “specifically designed to” in hardware. Instead, the expression “a device configured to” may refer to a situation in which the device is “capable of” operating together with another device or other components. For example, a “processor configured to (or set to) perform A, B, and C” may refer to a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

Terms used in this disclosure are used to describe the various embodiments and are not intended to limit the scope of another embodiment. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of this disclosure. In some cases, even if terms are terms which are defined in this disclosure, they may not be interpreted to exclude embodiments of this disclosure.

An electronic device according to various example embodiments of this disclosure may include at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to various embodiments, the wearable device may include at least one of an accessory type (e.g., watches, rings, bracelets, anklets, necklaces, glasses, contact lens, or head-mounted-devices (HMDs), a fabric or garment-integrated type (e.g., an electronic apparel), a body-attached type (e.g., a skin pad or tattoos), or a bio-implantable type (e.g., an implantable circuit), or the like, but is not limited thereto.

According to various example embodiments, the electronic device may be a home appliance. The home appliances may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ or PlayStation™), electronic dictionaries, electronic keys, camcorders, electronic picture frames, or the like, but is not limited thereto.

According to another example embodiment, an electronic device may include at least one of various medical devices (e.g., various portable medical measurement devices (e.g., a blood glucose monitoring device, a heartbeat measuring device, a blood pressure measuring device, a body temperature measuring device, and the like), a magnetic resonance angiography (MRA), a magnetic resonance imaging (MRI), a computed tomography (CT), scanners, and ultrasonic devices), navigation devices, Global Navigation Satellite System (GNSS), event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales (POSs) of stores, or internet of things (e.g., light bulbs, various sensors, electric or gas meters, sprinkler devices, fire alarms, thermostats, street lamps, toasters, exercise equipment, hot water tanks, heaters, boilers, and the like), or the like, but is not limited thereto.

According to an example embodiment, the electronic device may include at least one of parts of furniture or buildings/structures, electronic boards, electronic signature receiving devices, projectors, or various measuring instruments (e.g., water meters, electricity meters, gas meters, or wave meters, and the like), or the like, but is not limited thereto. According to various example embodiments, the electronic device may be one of the above-described devices or a combination thereof. An electronic device according to an embodiment may be a flexible electronic device. Furthermore, an electronic device according to an embodiment of this disclosure may not be limited to the above-described electronic devices and may include other electronic devices and new electronic devices according to the development of technologies.

Hereinafter, electronic devices according to various example embodiments will be described with reference to the accompanying drawings. In this disclosure, the term “user” may refer to a person who uses an electronic device or may refer to a device (e.g., an artificial intelligence electronic device) that uses the electronic device.

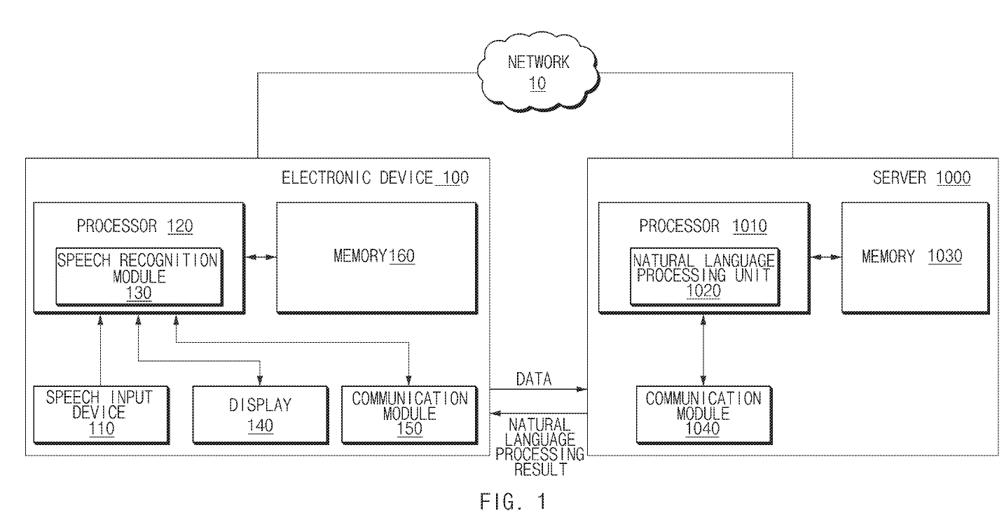

FIG. 1 is a diagram illustrating an example electronic device and an example server connected with the electronic device through a network, according to an example embodiment of the present disclosure.

Referring to FIG. 1, an electronic device 100 in various embodiments may include a speech input device (e.g., including speech input circuitry) 110, a processor (e.g., including processing circuitry) 120, a speech recognition module (e.g., including processing circuitry and/or program elements) 130, a display 140, a communication module (e.g., including communication circuitry) 150, and a memory 160. The configuration of the electronic device 100 illustrated in FIG. 1 is illustrative, and various modifications capable of implementing various embodiments of the present disclosure are possible. Hereinafter, various embodiments of the present disclosure will be described on the basis of the electronic device 100.

The electronic device 100 may obtain a speech (or utterance) from a user through the speech input device 110 (e.g., a microphone). In an embodiment, the electronic device 100 may obtain, through the speech input device 110, a speech for activating speech recognition and/or a speech corresponding to a speech instruction. The speech for activating speech recognition may be, for example, a preset keyword, such as “Hi, Galaxy.” The speech corresponding to a speech instruction may be, for example, “What is the weather today?”

The processor 120 may include various processing circuitry and provide, to the speech recognition module 130 and the communication module 150, a speech input obtained by the speech input device 110 or a speech signal generated based on the speech input. The speech signal provided by the processor 120 may be a pre-processed signal for more accurate speech recognition.

The processor 120 may include various processing circuitry and control general operations of the electronic device 100. For example, the processor 120 may control the speech input device 110, may control the speech recognition module 130 to perform a speech recognition operation, and may control the communication module 150 to perform communication with another device (e.g., a server 1000). In another embodiment, the processor 120 may perform an operation corresponding to a speech input, or may control the display 140 to display the operation corresponding to the speech input on a screen.

The speech recognition module 130 may include various processing circuitry and/or program elements and perform speech recognition on a speech signal. According to an embodiment, the speech recognition module 130 may recognize a speech instruction when a speech recognition activation condition is satisfied (e.g., when the user executes an application relating to speech recognition, when the user utters a specific speech input (e.g., “Hi, Galaxy”), when the speech input device 110 recognizes a specific keyword (e.g., “Hi, Galaxy”), when a specific hardware key is recognized, or the like). According to another embodiment, speech recognition of the electronic device 100 may always be in an activated state. The processor 120 may receive a recognized speech signal from the speech recognition module 130 and may convert the speech signal into a text.

The communication module 150 may include various communication circuitry and transmit a speech signal provided by the processor 120 to the server 1000 through a network 10. The communication module 150 may receive, from the server 1000, a natural language processing result for the speech signal. According to an embodiment, the natural language processing result may be a natural language understanding result. The natural language understanding result may be basic information for performing a specific operation. The natural language understanding result may be information about a domain, intent, and/or a slot that is obtained by analyzing a speech signal. For example, in the case where a user speech input is “Please set an alarm two hours later”, a natural language understanding result may be information, such as “alarm”, “set an alarm”, and “two hours later”.

According to another embodiment, the natural language processing result may be information about a service that the electronic device 100 has to perform on the basis of the natural language understanding result. According to another embodiment, the natural language processing result may be a service execution result based on the natural language understanding result. It will be understood that the foregoing are merely examples, and that the present disclosure is not limited thereto.

The electronic device 100 or the server 1000 may manage the natural language processing result in the form of a group that includes the information or a part thereof.

The display 140 may be used to interact with a user input. For example, if a user provides a speech input through the speech input device 110, a speech recognition result may be displayed on the display 140. A service execution result for the speech input may be displayed on the display 140. The service execution result may be, for example, an execution result of an application (e.g., a weather application, a navigation related application, or the like) according to a natural language processing result.

The server 1000 may include a configuration for performing natural language processing on a speech input provided from the electronic device 100 through the network 10. According to various embodiments, some elements of the server 1000 may correspond to those of the electronic device 100. For example, the server 1000 may include a processor (e.g., including processing circuitry) 1010, a memory 1030, a communication module (e.g., including communication circuitry) 1040, and the like. According to an embodiment, the server 1000 may further include a natural language processing (NLP) unit (e.g., including processing circuitry and/or program elements) 1020.

The processor 1010 may include various processing circuitry and control function modules for performing natural language processing in the server 1000. For example, the processor 1010 may be connected with the natural language processing unit 1020.

The natural language processing unit 1020 may include various processing circuitry and/or program elements and perform natural language processing on a speech signal received from the electronic device 100. For an input speech unit, the natural language processing unit 1020 may determine intent and/or a domain for a user input. The natural language processing unit 1020 may generate a natural language processing result for the user input by, for example, and without limitation, natural language understanding (NLU), dialog management (DM), or a combination thereof. Through the natural language processing, various matching results available may be derived rather than any one result.

The communication module 1040 may include various communication circuitry and transmit the natural language processing result to the electronic device 100 through the network 10 as a processing result of the natural language processing unit 1020.

Various modifications may be made to the configuration of the electronic device 100 or the server 1000 illustrated in FIG. 1, as described above. In another embodiment, the speech recognition module 130 may, for example, and without limitation, be implemented by the server 1000. In another embodiment, the natural language processing unit 1020 may, for example, and without limitation, be implemented by the electronic device 100.

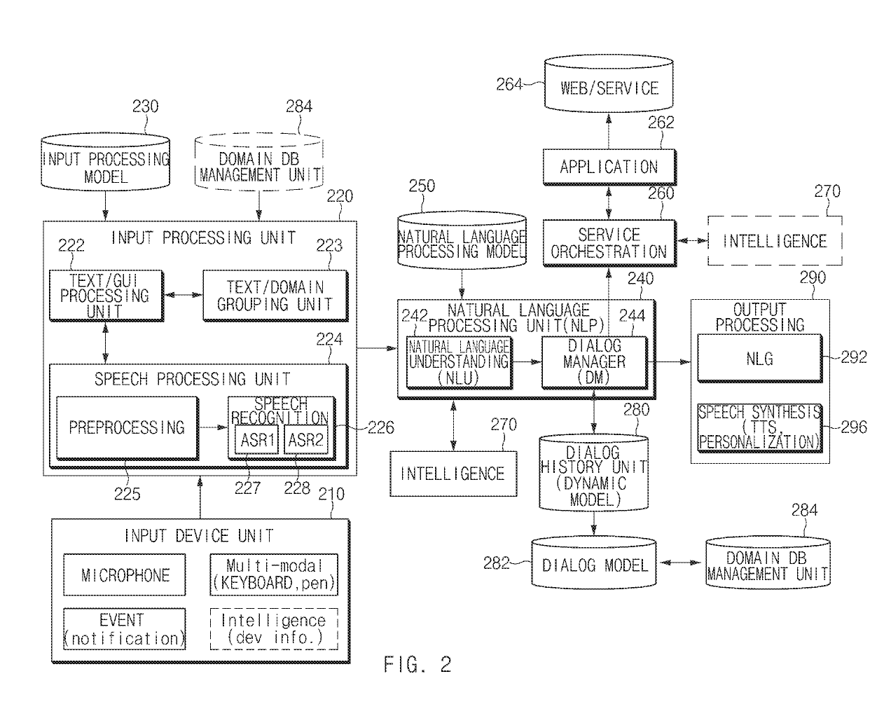

FIG. 2 is a diagram illustrating an example electronic device and a server, according to another example embodiment of the present disclosure.

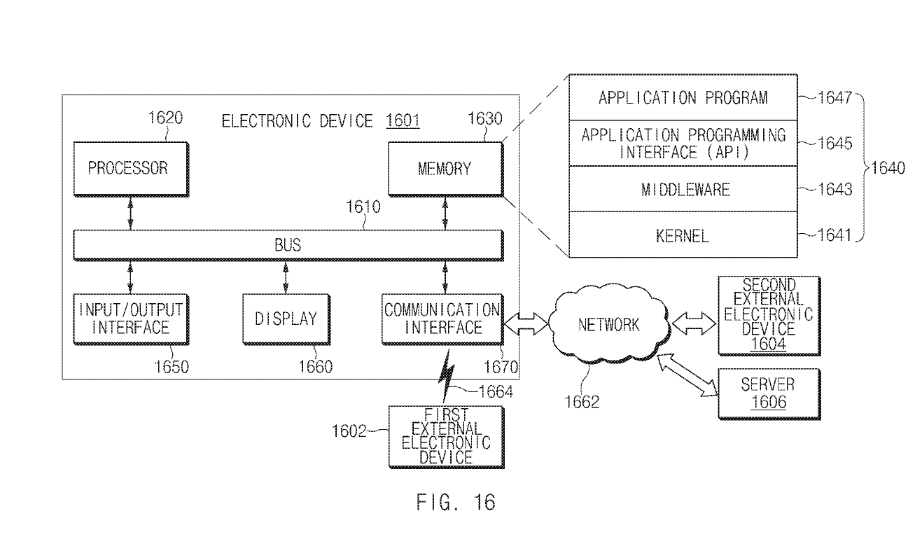

FIG. 2 illustrates a processing system that includes an electronic device implemented in a different way than that of FIG. 1. The processing system may include the electronic device 100 and the server 1000 illustrated in FIG. 1. According to an embodiment, the processing system may be understood as including at least one piece of user equipment and a plurality of servers operated by different subjects. A speech recognition method disclosed in this disclosure may be performed not only by the electronic device of FIG. 1 or 2 or an electronic device of FIGS. 16 to 18, which will be described below, but also by various forms of devices that may be derived from the electronic devices.

Referring to FIG. 2, the processing system may include an input device unit (e.g., including input circuitry) 210, an input processing unit (e.g., including processing circuitry) 220, an input processing model (e.g., including processing circuitry and/or program elements) 230, a natural language processing unit (e.g., including processing circuitry and/or program elements) 240, a natural language processing model 250, service orchestration 260, an application 262, intelligence 270, a dialog history unit 280, a dialog model 282, a domain database (DB) management unit 284, and an output processing unit (e.g., including processing circuitry) 290 to perform embodiments of the present disclosure. These elements may communicate with one another through one or more buses or networks. In an embodiment, all functions to be described with reference to FIG. 2 may be performed by a server or a client (e.g., the electronic device 100). In another embodiment, some of the functions may be implemented by the server, and the other functions may be implemented by the client.

According to various embodiments of the present disclosure, the electronic device 100 or the server 1000 may interact with a web server or a service provider (hereinafter, referred to as a web/service 264), which provides a web-based service, through a network.

The input device unit 210 may include various input circuitry, such as, for example, and without limitation, one or more of a microphone, a multi-modal (e.g., a pen, a keyboard, or the like), an event (notification), and the like. The input device unit 210 may receive inputs from a terminal user through various sources, such as an input tool of a terminal, an external device, and/or the like. For example, the input device unit 210 may receive an input by using a user's keyboard input or a device that generates text. The input device unit 210 may receive the user's speech input or a signal from a speech input system. Furthermore, the input device unit 210 may receive a user input (e.g., a click or selection of a GUI object, such as an icon) through a graphic user interface (GUI).

According to an embodiment, a user input may also include an event occurring in the terminal. According to some embodiments, a user input may be an event occurring from an external device. For example, there are a message mail arrival notification, a scheduling event occurrence notification, and a third-party push notification. According to some embodiments, a user input may be a multi-input (e.g., simultaneous receipt of a user's text input and speech input) through a multi-modal or a multi-modal interface.

The input processing unit 220 may include various processing circuitry and/or program elements that process an input signal received from the input device unit 210. The input processing unit 220 may transfer the processed input signal to the natural language processing unit 240 (e.g., a natural language understanding unit 242). The input processing unit 220 may determine whether natural language processing is able to be performed on input signals, and may convert the input signals into signals comprehensible to the natural language processing unit 240. The input processing unit 220 may differently process input signals of respective input devices. The input processing unit 220 may include, for example, and without limitation, a text/GUI processing unit (e.g., including processing circuitry and/or program elements) 222, a text/domain grouping unit (e.g., including processing circuitry and/or program elements) 223, and a speech processing unit (e.g., including speech processing circuitry and/or program elements) 224.

According to various embodiments of the present disclosure, the text/GUI processing unit 222 may convert a user text input or a GUI object input received from an input device (e.g., a keyboard, a GUI, or the like) into a form comprehensible to the natural language processing unit 240. The text/GUI processing unit 222 may convert a speech signal processed by the speech processing unit 224 into a form comprehensible to the natural language processing unit 240.

According to various embodiments of the present disclosure, the text/domain grouping unit 223 may group speech signals, which have been converted into text, for each domain. The signals processed by the text/domain grouping unit 223 may be transferred to the domain DB management unit 284. In the case where the electronic device 100 or the server 1000 recognizes input of a user's specific text or speech bubble, the electronic device 100 or the server 1000 may extract domain information corresponding to the relevant text or speech bubble by using the text/domain grouping unit 223. For example, in the case where a user selects a text or speech bubble “Let me know tomorrow's weather”, the electronic device 100 or the server 1000 may extract weather domain information corresponding to the relevant text or speech bubble by using the text/domain grouping unit 223.

The speech processing unit 224 may determine whether a speech recognition activation condition is satisfied, in the case where a user input is detected through the input device unit 210 provided in the electronic device 100. The speech recognition activation condition may be differently set according to operations of input devices provided in the electronic device 100. The speech processing unit 224 may recognize a speech instruction in the case where the speech recognition activation condition is satisfied. The speech processing unit 224 may include a pre-processing unit (e.g., including processing circuitry and/or program elements) 225 and a speech recognition unit (e.g., including processing circuitry and/or program elements) 226.

The pre-processing unit 225 may perform processing for enhancing efficiency in recognizing an input speech signal. For example, the pre-processing unit 225 may use an end time detection (EPD) technology, a noise cancelling technology, an echo cancelling technology, or the like, but is not limited thereto.

The speech recognition unit 226 may, for example, and without limitation, include an automatic speech recognition 1 (ASR1) module (e.g., including processing circuitry and/or program elements) 227 associated with a speech recognition activation condition and an ASR2 module (e.g., including processing circuitry and/or program elements) 228 that is a speech instruction recognition module.

The ASR1 module 227 may determine whether a speech recognition activation condition is satisfied. The ASR1 module 227 may determine that a speech recognition activation condition based on a user input has been satisfied, in the case where the electronic device 100 detects a short or long press input of a physical hard or soft key, such as a button type key (e.g., a power key, a volume key, a home key, or the like) or a touch key (e.g., a menu key, a cancel key, or the like) provided in the electronic device 100, or detects a specific motion input (or gesture input) through a pressure sensor or a motion sensor.

The speech recognition unit 226 may transfer an obtained speech signal to a speech instruction recognition module (e.g., the ASR2 module 228) in the case where a speech recognition activation condition is satisfied for a user input.

The natural language processing unit 240 may include the natural language understanding (NLU) unit (e.g., including processing circuitry and/or program elements) 242 and a dialog manager (DM) (e.g., including processing circuitry and/or program elements) 244.

For an input speech unit, the NLU unit 242 may determine intent of a user input or a matched domain by using the natural language processing model 250. The DM 244 may manage a user dialog history and may manage a slot or a task parameter. The DM 244 may extract domain, intent, and/or slot information from the dialog history unit 280 and/or the domain DB management unit 284.

The NLU unit 242 may perform syntactic analysis and semantic analysis on an input unit. According to analysis results, the NLU unit 242 may determine a domain or intent to which the relevant input unit corresponds, and may obtain elements (e.g., a slot and a parameter) necessary for representing the relevant intent. In this process, the NLU unit 242 may discover various matching results available rather than any one result. The domain, intent, and slot information obtained by the NLU unit 242 may be stored in the dialog history unit 280 or the domain DB management unit 284.

To determine a user's intent, the NLU unit 242 may, for example, and without limitation, use a method of matching matchable syntactic elements to respective cases with a matching rule for a domain/intent/slot, or may use a method of determining a user's intent by extracting linguistic features for a user language and discovering models that the corresponding features match.

The DM 244 may determine the next action on the basis of the intent determined through the NLU unit 242. The DM 244 may determine whether the user's intent is clear. The clarity of the user's intent may be determined, for example, depending on whether slot information is sufficient. The DM 244 may determine whether a slot determined by the NLU unit 242 is sufficient to perform a task, whether to request additional information from a user, or whether to use information about a previous dialog. The DM 244 may be a subject that requests necessary information from the user or provides and receives feedback for a user input.

The service orchestration (e.g., including processing circuitry and/or program elements) 260 may obtain a task that has to be performed based on a natural language processing result. The task may correspond to a user's intent. The service orchestration 260 may link the obtained task and a service. The service orchestration 260 may serve to call and execute a service (e.g., the application 262) that corresponds to the user's determined intent. The service orchestration 260 may select at least one of a plurality of applications and/or services to perform a service.

The service corresponding to the user's intent may be an application installed in the electronic device 100, or may be a third-party service. For example, a service used to set an alarm may be an alarm application or a calendar application installed in the electronic device 100. According to an embodiment, the service orchestration 260 may select and execute an application most appropriate for obtaining a result corresponding to the user's intent, among a plurality of applications installed in the electronic device 100. According to an embodiment, the service orchestration 260 may select and execute an application according to the user's preference, among a plurality of applications.

The service orchestration 260 may search for a service appropriate for the user's intent by using a third-party application programming interface (API) and may provide the discovered service.

The service orchestration 260 may use information stored in the intelligence 270 to connect a task and a service. The service orchestration 260 may determine an application or a service that is to be used to perform an obtained task, based on the information stored in the intelligence 270. According to an embodiment, the service orchestration 260 may determine an application or a service based on user context information. For example, in the case where the user's intent is to send a message and a task is to execute a message application, the service orchestration 260 may determine an application that is to be used to send a message. In this case, the service orchestration 260 may obtain user context information (e.g., information about an application that is mainly used to send a message) from the intelligence 270.

In the case where a plurality of intents or domains are matched according to a natural language processing result, the service orchestration 260 may simultaneously or sequentially perform services corresponding to the relevant domains. For example, the service orchestration 260 may simultaneously or sequentially execute applications corresponding to the domains.

The service orchestration 260 may be included in the electronic device 100 and/or the server 1000. According to another embodiment, the service orchestration 260 may be implemented with a server separate from the server 1000.

The intelligence 270, which is information for helping natural language processing, may include information, such as the last dialog history, the last user selection history (an outgoing call number, a map selection history, or a media playback history), and a web browser cookie. In the case where a natural language is processed, the intelligence 270 may be used to accurately determine the user's intent and to perform a task.

The dialog history unit 280 may store a history regarding the user's speech input by using the dialog model 282. For a speech input, the dialog history unit 280 may store detailed information obtained based on natural language processing in the NLU unit 242 and the DM 244. For example, the dialog history unit 280 may store domain, intent, and/or slot information for a speech input. The dialog history unit 280 may store detailed information about the last speech input. For example, the dialog history unit 280 may store detailed information about a user speech input that is input for a predetermined session. In another example, the dialog history unit 280 may store detailed information about a user speech input that is input for a predetermined period of time. In another example, the dialog history unit 280 may store detailed information about a predetermined number of user speech inputs. The dialog history unit 280 may be configured separately from the intelligence 270, or may be included in the intelligence 270. In an embodiment of the present disclosure, the dialog history unit 280 may store detailed information about the last speech input and detailed information about a speech input prior to the last speech input. The dialog history unit 280 may store detailed information about a corresponding speech input in the form of a set of specific information, such as <domain, intent, slot, slot, . . . >, according to interpretation. Table 1 below shows information stored in the dialog history unit 280 in correspondence to speech inputs.

TABLE 1

| Speech contents | Domain | Intent | Slot | Slot | Slot |
|---|---|---|---|---|---|
| Let me know surrounding | Famous | Area search | Place: | | |
| famous restaurants. | restaurant | | surroundings | | |
| Let me know tomorrow's | Weather | Weather | Place: current | Day: | |
| weather. | | check | position | tomorrow | |
| Let me know way to | Navigation | Get direction | | | Destination: |
| Everland. | | | | | Everland |

The domain DB management unit 284 may store a domain corresponding to the last speech input and/or frequently-used domain information. The domain DB management unit 284 may store domain information grouped together with a text (or a speech bubble) corresponding to a user speech input. The domain DB management unit 284 may store contents (e.g., icons) that match the domain corresponding to the last speech input and/or the frequently-used domain information. The domain DB management unit 284 may operate in conjunction with the dialog history unit 280. The domain DB management unit 284 may store the domain corresponding to the last speech input and/or the frequently-used domain information, among detailed information, such as domains, intents, and/or slots stored in the dialog history unit 280. The domain DB management unit 284 may also store relevant slot information.

The domain DB management unit 284 may also operate in conjunction with the input processing unit 220. The domain DB management unit 284 may preferably operate in conjunction with the text/domain grouping unit 223. The domain DB management unit 284 may store a text and a domain grouped in the text/domain grouping unit 223. The domain DB management unit 284 may store a text, a domain, and/or a slot that are grouped together. In response to a user's selection of a specific text, the domain DB management unit 284 may provide a domain and/or a slot grouped together with the specific text. The domain DB management unit 284 may also provide a domain corresponding to a text (or a speech bubble) selected by the user. In response to the user's selection of contents, the domain DB management unit 284 may provide a domain associated with the corresponding contents. In an embodiment of the present disclosure, a dialog management procedure may be performed on a domain obtained from the domain DB management unit 284 without separate natural language understanding. In another embodiment, the domain DB management unit 284 may be omitted, or may be integrated with the dialog history unit 280.

The output processing unit (e.g., including processing circuitry and/or program elements) 290 may include a natural language generation unit (e.g., including processing circuitry and/or program elements) 292 for generating input data in a natural language form and a text-to-speech (TTS) unit (e.g., including processing circuitry and/or program elements) 296 for performing speech synthesis to provide a text form of result in a speech form. The output processing unit 290 may serve to configure a result generated by the natural language processing unit 240 and to make the result subject to rendering. The output processing unit 290 may perform various forms of outputs, such as texts, graphics, speeches, and the like. In the case where two or more domains correspond to a speech input, the output processing unit 290 may output a plurality of service execution results and/or application execution results that correspond to each domain.

Hereinafter, a correlation between a domain, intents, and slots will be described, and a method of determining a matched domain according to some embodiments of the present disclosure will be described.

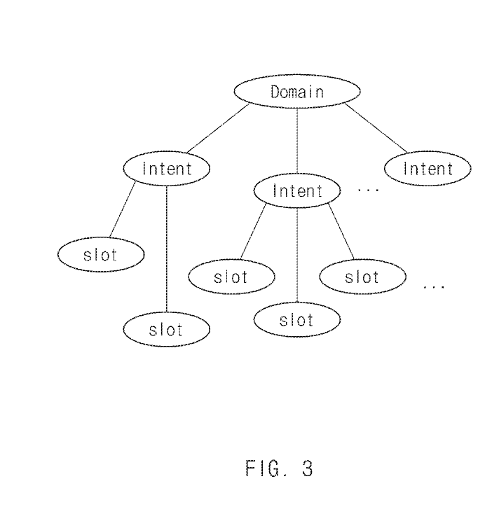

FIG. 3 is a diagram illustrating example correlation between a domain, intents, and slots, according to various example embodiments of the present disclosure.

Referring to FIG. 3, for natural language processing, the processing system may store information about a correlation between a domain, intents, and slots. In an embodiment, the domain, the intents, and the slots may form a tree structure. The processing system may store intent and slot information for a plurality of domains. The intents may correspond to sub-nodes of the domain, and the slots may correspond to sub-nodes of the intents. The domain may correspond to a set of specific attributes and may be replaced with the term “category”. The intents may represent actionable attributes associated with the domain. In an embodiment, the slots may represent specific attributes (e.g., time, a place, or the like) that the intents may have. A domain may include a plurality of intents as sub-nodes, and intent may include a plurality of slots as sub-nodes. In an embodiment, a slot may correspond to a sub-node of a plurality of domains.

According to an embodiment, in the case where a user utters “Please, set an alarm for 6:00 a.m. tomorrow”, the natural language processing unit 240 may know that the input word “alarm” corresponds to the domain “alarm” and may therefore know that “set an alarm” in the user speech corresponds to the intent “set an alarm”. The natural language processing unit 240 may determine that “6:00 a.m.” corresponds to <type: time> among a plurality of slots for setting an alarm, and may determine that the user has intent to set an alarm for the corresponding time. The natural language processing unit 240 may transfer a natural language processing result to the service orchestration 260 or the output processing unit 290.

The natural language processing unit 240 may also perform an operation of searching for a domain that matches a user input. If a user input matches a specific domain, this may mean that the specific domain includes a slot corresponding to the user speech as a sub-node in FIG. 3.

For example, the user may already have uttered “Let me know surrounding famous restaurants”, “Let me know tomorrow's weather”, and “Play back music”, and these speeches may constitute a user input history. In this case, <famous restaurant, area search, place: surroundings>, <weather, weather check, day: tomorrow, place: current position>, and <music, playback, music title: recent playback list> may be stored in the dialog history unit 280 or the domain DB management unit 284 for the respective speeches according to <domain, intent, slot, slot, . . . >.

Thereafter, in the case where the user utters “Sokcho”, the natural language processing unit 240 may obtain a domain having meaningful information by substituting the speech “Sokcho” into slots for each speech. Since “Sokcho” corresponds to a slot representing a place, the natural language processing unit 240 may determine that the domain “famous restaurant” matches “Sokcho”, according to <famous restaurant, area search, place: Sokcho>. The natural language processing unit 240 may determine that the domain “weather” matches “Sokcho”, according to <weather, weather check, day: tomorrow, place: Sokcho>. In contrast, since “Sokcho” in <music, playback, music title: Sokcho> does not correspond to a music title, the natural language processing unit 240 may determine that the domain “music” does not match “Sokcho”.

The natural language processing unit 240 may determine intent on the basis of the matched domain and slot. The natural language processing unit 240 may transfer the matched domain or the determined intent to the service orchestration 260. The service orchestration 260 may perform an operation associated with the matched domain or the determined intent. The output processing unit 290 may output a service execution result in a form that the user is to recognize.

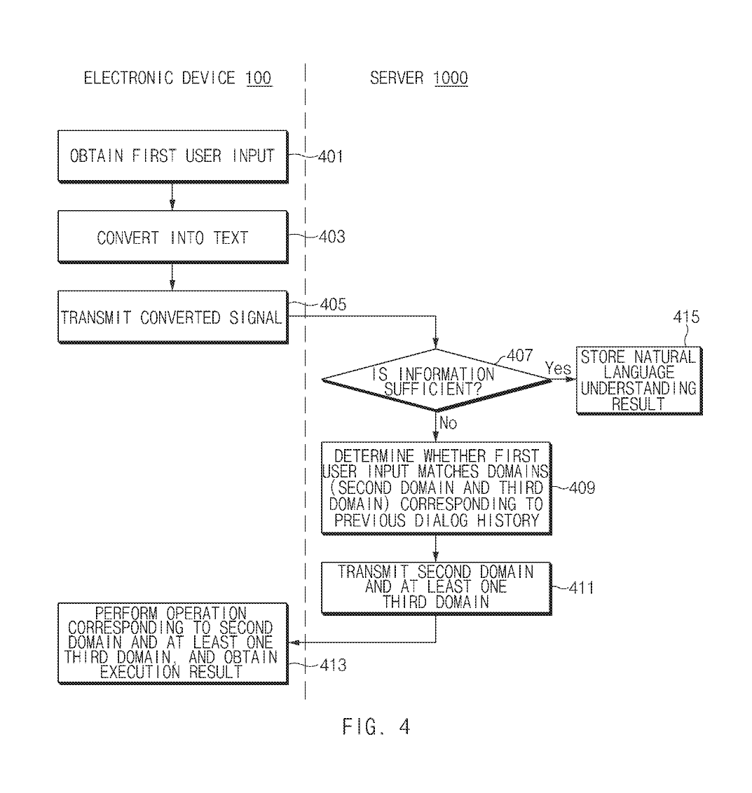

Hereinafter, a method of processing various inputs will be described in greater detail with reference to FIGS. 4 to 15.

FIG. 4 is a flowchart illustrating an example speech input processing method according to an example embodiment of the present disclosure.

For example, FIG. 4 illustrates operations of the electronic device 100 and the server 1000 for a current user input (hereinafter, referred to as a first user input). Hereinafter, it is assumed that, before receiving the first user input, the electronic device 100 has received the most recent user input (hereinafter, referred to as a second user input or the last user input) and one or more user inputs (hereinafter, referred to as third user inputs) followed by the most recent user input.

In operation 401, the electronic device 100 may obtain the first user input through an input device (e.g., a microphone). Operation 401 may be performed in the state in which a specific function or application associated with speech recognition has been executed by a user. However, in some embodiments, speech recognition may always be in an activated state, and operation 401 may always be performed on the user's speech. As described above, recognition of a speech instruction may be activated by a specific speech input (e.g., Hi, Galaxy), and in operation 401, speech recognition may be performed on a speech instruction (e.g., the first user input) that is input after the specific speech input.

In operation 403, the electronic device 100 may convert the speech signal into a text signal that the electronic device 100 is to recognize.

In operation 405, the electronic device 100 may transmit the speech signal, which has been converted into the text signal, to the server 1000 using a communication module.

The server 1000 may attempt natural language processing on the basis of the converted signal. In operation 407, the server 1000 may determine whether the transferred signal has information sufficient to determine intent. In the case where the transferred signal has information sufficient to determine intent, the server 1000 may, in operation 415, obtain a natural language understanding result and may store the natural language understanding result. The natural language understanding result may include domain, intent, and/or slot information. The server 1000 may specify the next service operation on the basis of the natural language understanding result. According to an embodiment, in the case where the information is insufficient for natural language processing, the server 1000 may perform the following operations.

In operation 409, the server 1000 may search a previous dialog history to obtain a domain matching the first user input. The server 1000 may obtain a matched domain by extracting domain, intent, and/or slot information stored in the previous dialog history and substituting the first user input into each element. According to an embodiment, the server 1000 may determine whether the first user input matches a second domain corresponding to the second user input and whether the first user input matches third domains corresponding to the one or more third user inputs. The server 1000 may determine the second domain and/or the one or more third domains to be domains matching the first user input. Furthermore, the server 1000 may obtain a plurality of user intents on the basis of the second domain, the one or more third domains, and the first user input.

According to an embodiment, the server 1000 may not determine whether the first user input matches duplicated domains, or a domain overlapping the second domain, among the one or more third domains.

Meanwhile, a dialog history corresponding to the one or more third user inputs may be managed by the domain DB management unit 284. The domain DB management unit 284 may impose a predetermined restriction (e.g., a time period, the number of times, or the like) on the stored dialog history.

In operation 411, the server 1000 may transmit a natural language processing result to the electronic device 100. The natural language processing result may include information about the matched domain. The information about the matched domain may include information about the second domain matching the first user input and the one or more third domains matching the first user input. The information transmitted from the server 1000 to the electronic device 100 may be referred to as a natural language processing result.

In operation 413, the electronic device 100 may determine the user's intent on the basis of the matched second domain and the matched one or more third domains. The electronic device 100 may perform a relevant operation (or service) according to the user's determined intent and may obtain a service execution result (e.g., an application execution result).

As described above, the electronic device 100 may search the previous dialog history for a matched domain and may obtain all service execution results associated with a plurality of domains. Therefore, the electronic device 100 may rapidly and easily provide desired information to the user.

According to another embodiment, referring to operation 411 of FIG. 4, the natural language processing result may be domain, slot, and/or intent information that is a natural language understanding result. The electronic device 100 may receive a natural language processing result from the server 1000, may perform a relevant operation (or service) according to intent on the basis of the received information, and may obtain a service execution result.

According to another embodiment, referring again to operation 411 of FIG. 4, the natural language processing result may be the service execution result. According to this embodiment, the server 1000 may obtain a natural language understanding result, may execute a service on the basis of the corresponding understanding result, and may obtain a service execution result. In this case, the service execution result may include a service execution result associated with the second domain and/or service execution results associated with the one or more third domains. The service execution result may be displayed on the screen of the electronic device 100. For example, an application execution result may be displayed in an abridged form on the screen. The user may select desired information to specifically identify the information. For example, the user may select the desired information through a gesture, such as a touch.

Meanwhile, the electronic device 100 may match the obtained domain information with the user input and may transfer the matched information to the domain DB management unit 284.

While the operations in FIG. 4 have been described as being performed by the server 1000 and the electronic device 100, the operations may be performed by only the electronic device 100, as described above. According to another embodiment, some operations of the server 1000 may be performed by the electronic device 100, and some operations of the electronic device 100 may be performed by the server 1000. For example, the electronic device 100 may obtain the first user input and may transmit the first user input to the server 1000. Furthermore, the server 1000 may determine intent on the basis of the second domain and/or the one or more third domains and may obtain a service execution result according to the determined intent, as described above. In this case, the server 1000 may transmit the service execution result to the electronic device 100.

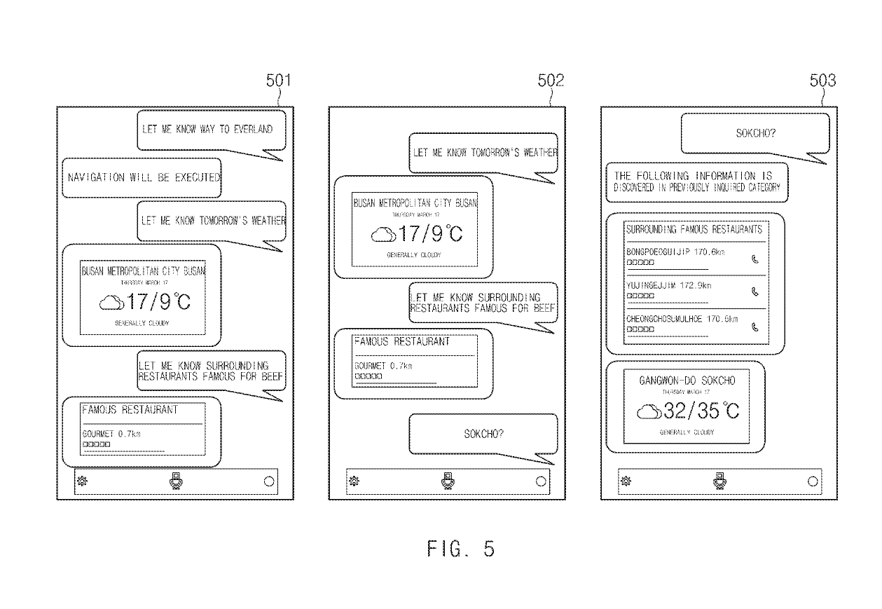

FIG. 5 is a diagram illustrating an example user interface displayed on the electronic device 100, according to various example embodiments of the present disclosure.

Referring to FIG. 5, prior to a first user input, a previous dialog history including display of a plurality of previous speeches based on different domains may be displayed on a screen 501. For example, the dialog history displayed on the screen 501 may include a third user input “Let me know way to Everland”, a third application execution result “Navigation will be executed” as a response to the third user input, another third user input “Let me know tomorrow's weather”, another third application execution result associated with weather as a response to the other third user input, a second user input “Let me know surrounding restaurants famous for beef”, and second application related information associated with famous restaurants as a response to the second user input.

A screen 502 of FIG. 5 may be a user interface (UI) screen in the case where a user's new speech (the first user input) is entered. The electronic device 100 may display a speech recognition result of the first user input on the screen 502 in response to the first user input. For example, in the case where the user utters an incomplete sentence “Sokcho”, the electronic device 100 may display “Sokcho” as a speech recognition result.

A screen 503 of FIG. 5 may provide a user interface for displaying a service execution result in response to the first user input. In the case where an incomplete sentence, such as “Sokcho”, is entered, a plurality of domains and intents may be derived for the first user input according to some embodiments of the present disclosure. In this case, the electronic device 100 may display, on the screen 503, all service execution results for the plurality of domains and intents. Hereinafter, various embodiments for displaying the service execution results will be described under the assumption that the service execution results are application execution results.

For example, for “Sokcho” corresponding to a place slot, a domain matching the first user input may include both “famous restaurant” and “weather”. In this case, the electronic device 100 may display, on the screen 503, application execution results that correspond to intents to search for famous restaurants and weather.

In an example of a method of displaying the application execution results, the application execution results may be displayed on the user interface in the order of the most recent dialog history. Referring to the screen 503, a result regarding famous restaurants may be displayed on the user interface before a result regarding weather according to the order of the most recent dialog history.

In another example of a method of displaying the application execution results, the electronic device 100 may display the plurality of application execution results in a single speech bubble or may display the application execution results in speech bubbles, respectively.

In another example of a method of displaying the application execution results, the electronic device 100 may display all of the plurality of application execution results for one user input before the next user input is entered.

In another example of a method of displaying the application execution results, the electronic device 100 may display only the second application execution result in response to the first user input. In this case, the electronic device 100 may request, from the user, a response regarding whether to additionally display an application execution result associated with a matched third domain. For example, only the result regarding the weather may be preferentially displayed on the user interface in succession to the display of the screen 502, and a question “Would you check a result for a different category?” may be displayed on the user interface. In the case where the user enters an affirmative answer, such as “yes (in Korean)” or “yes”, or performs a specific gesture in response to the question, the electronic device 100 may display an application execution result associated with the matched third domain.

As described above, according to embodiments of the present disclosure, for the user's speech, the electronic device 100 may output a plurality of operation execution results associated with previous domain information and a new domain.

The electronic device 100 may display contents (e.g., icons) associated with domains to allow the user to more intuitively recognize relevant domain information. According to another embodiment, if a domain to be updated is present in previous domain information, the electronic device 100 may display the fact that contents in the previous domain information have been updated, on the screen through the contents (e.g., icons). For example, the electronic device 100 may use an icon to indicate that updating has been performed. In the case where contents have been updated in a specific domain, the electronic device 100 may change the state (e.g., color, contrast, shape, or the like) of an icon associated with the corresponding specific domain. For this operation, the domain DB management unit 284 may store a correlation between the domain and the icon.

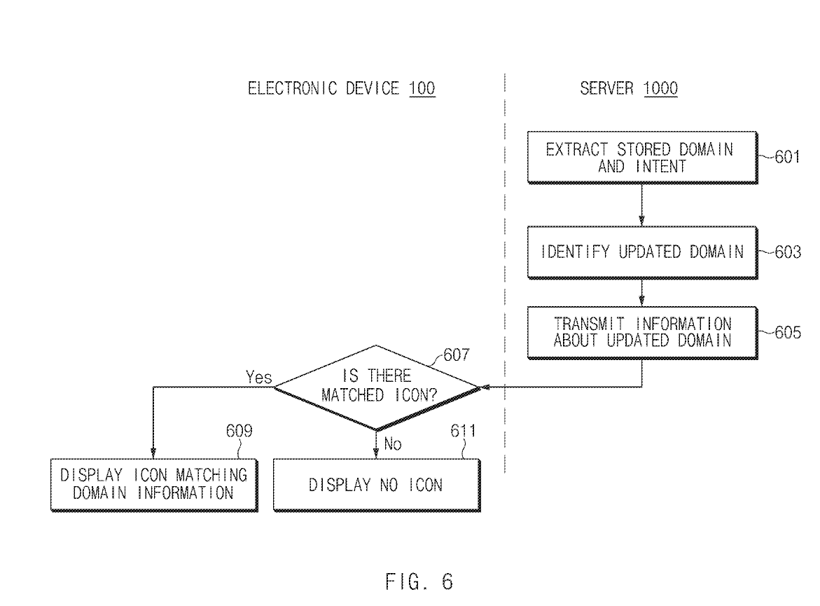

FIG. 6 is a flowchart illustrating an example input processing method according to another example embodiment of the present disclosure.

Hereinafter, a method of displaying contents associated with domains will be described with reference to FIG. 6. For the convenience of description, contents are assumed to be icons.

In operation 601, the server 1000 may extract stored domains and intents. For example, the server 1000 may search the dialog history unit 280 or the domain DB management unit 284 to extract the domains and intents. Here, it is assumed that information obtained based on a natural language understanding result and/or information obtained based on embodiments of the present disclosure is stored in the dialog history unit 280 or the domain DB management unit 284.

In operation 603, the server 1000 may identify an updated domain. For example, the domain DB management unit 284 may update a domain by using the extracted domains and intents.

The domain DB management unit 284 may periodically update a domain in the case where a specific event occurs, such as when there is a user's initial input or when there is an additional user input. Here, updating the domain may mean changing the domain itself or changing detailed contents (e.g., slots) of the domain.

In operation 605, the server 1000 may transmit information about the updated domain to the electronic device 100.

In operation 607, the electronic device 100 may determine whether there is a matched icon. Information about an icon may be stored in the domain DB management unit 284.

In the case where there is a matched icon, the electronic device 100 may, in operation 609, display the icon matching the domain. On the other hand, in the case where there is no matched icon, the electronic device 100 may display nothing.

While the operations in FIG. 6 have been described as being performed by the server 1000 and the electronic device 100, the operations may be performed by only the electronic device 100 as described above. In another embodiment, some operations of the server 1000 may be performed by the electronic device 100, and some operations of the electronic device 100 may be performed by the server 1000.

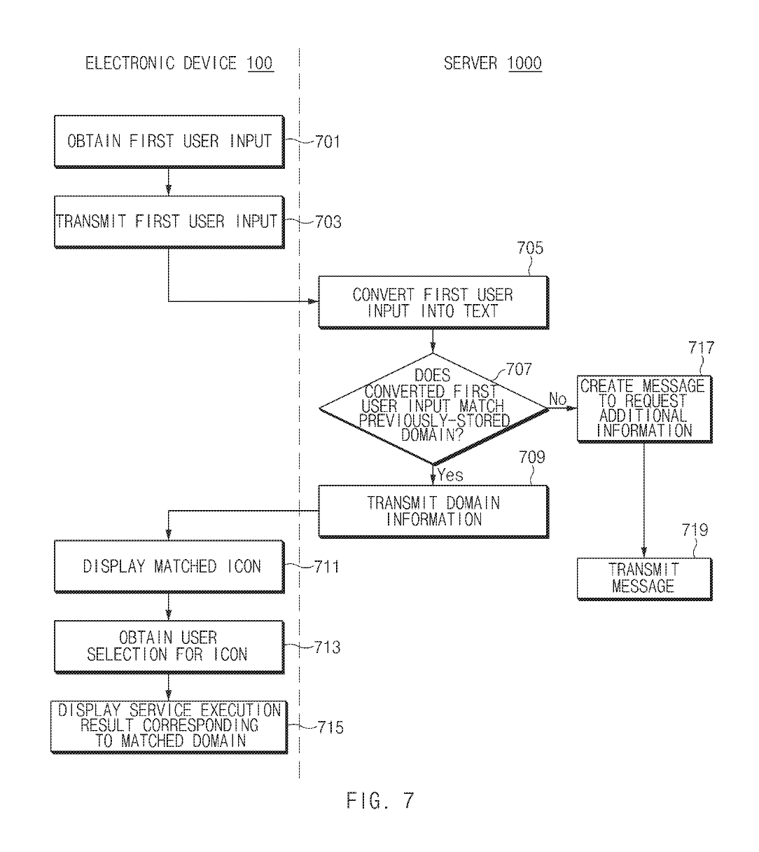

FIG. 7 is a flowchart illustrating an example input processing method according to another example embodiment of the present disclosure.

The electronic device 100 may display contents (e.g., icons) associated with domains to allow a user to more intuitively recognize domain information associated with a user input. Hereinafter, for the convenience of description, contents are assumed to be icons.

The electronic device 100 may activate or deactivate the icons. Accordingly, the user may intuitively identify domain information associated with a user input. Here, activating or deactivating an icon may mean changing the state (e.g., color, contrast, shape, or the like) of an icon associated with a specific domain.

Referring to FIG. 7, since speech obtaining operation 701 corresponds to operation 401 illustrated in FIG. 4, a description thereof will not be repeated.

In operation 703, the electronic device 100 may transmit the obtained first user input to the server 1000 by using a communication module.

In operation 705, the server 1000 may convert the first user input into a text signal that the electronic device 100 is to recognize.

In operation 707, the server 1000 may determine whether the converted first user input matches a previously-stored domain. Here, the previously-stored domain may mean a domain matching a previous dialog history as described above with reference to FIG. 3, as well as a domain stored in the server 1000 in advance. Operation 707 may be performed by the NLU unit 242 and/or the DM 244.

In the case where there is a matched domain, the server 1000 may, in operation 709, transmit information about the domain to the electronic device 100. Alternatively, the server 1000 may transmit information about an icon associated with the matched domain to the electronic device 100. In this case, contents associated with the matched domain may be stored in the dialog history unit 280 or the domain DB management unit 284 and may be linked with the domain.

The electronic device 100 may receive the information from the server 1000 and may, in operation 711, activate and display an icon. The electronic device 100 may receive information about a domain that is to be matched, and may display an icon linked to the corresponding domain. The electronic device 100 may output the linked icon on a screen or may change the state of the icon.

According to another embodiment, the electronic device 100 may also receive information about the icon matching the domain from the server 1000. In this case, the electronic device 100 may immediately display the icon.

In operation 713, the electronic device 100 may receive a user input for the icon. In the case where a plurality of icons are provided, the user may select a specific icon from the plurality of icons.

In operation 715, the electronic device 100 may output a service execution result on the basis of a domain associated with the selected icon. In response to the selection of the icon, a service corresponding to the user's intent may be performed. According to another embodiment, in response to the selection of the icon, one of a plurality of service execution results already extracted may be output.

A link relationship between an icon and a domain and between icons may be stored in the electronic device 100 and/or the domain DB management unit 284 of the server 1000. Meanwhile, in the case where the determination result in operation 707 shows that there is no matched domain, the server 1000 may, in operation 717, create a request message to inform the user, via the electronic device, that additional information is necessary. In operation 719, the server 1000 may transmit the request message to the electronic device 100.

Since a domain matching a user input is displayed in an icon form as described above, the user may more intuitively discern determination of the electronic device 100 as to his/her speech.

Meanwhile, although not illustrated in FIG. 7, the display of the speech recognition result for the first user input and/or the display of the service execution result for the first user input may be performed together with or after a change in the state of the icon.

Meanwhile, the electronic device 100 may match the obtained domain information with the user input and may transfer the matched information to the domain DB management unit 284. In another embodiment, the electronic device 100 may match the domain information input by the user and the user input and may transfer the matched information to the domain DB management unit 284.

While the operations in FIG. 7 have been described as being performed by the server 1000 and the electronic device 100, the operations may be performed by only the electronic device 100 as described above. According to another embodiment, some operations of the server 1000 may be performed by the electronic device 100, and some operations of the electronic device 100 may be performed by the server 1000. For example, the electronic device 100 may obtain the first user input and may convert the first user input into a text. The electronic device 100 may transmit, to the server 1000, the first user input converted into a text. Furthermore, the electronic device 100 may determine a domain matching the first user input. The electronic device 100 may obtain an icon associated with the matched domain and may display the icon on the screen thereof.

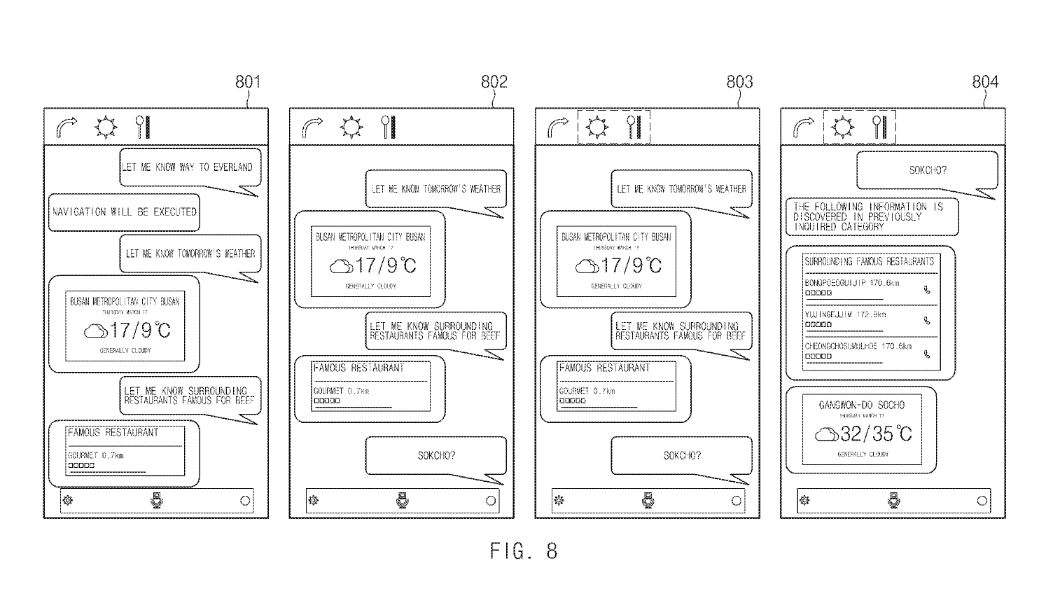

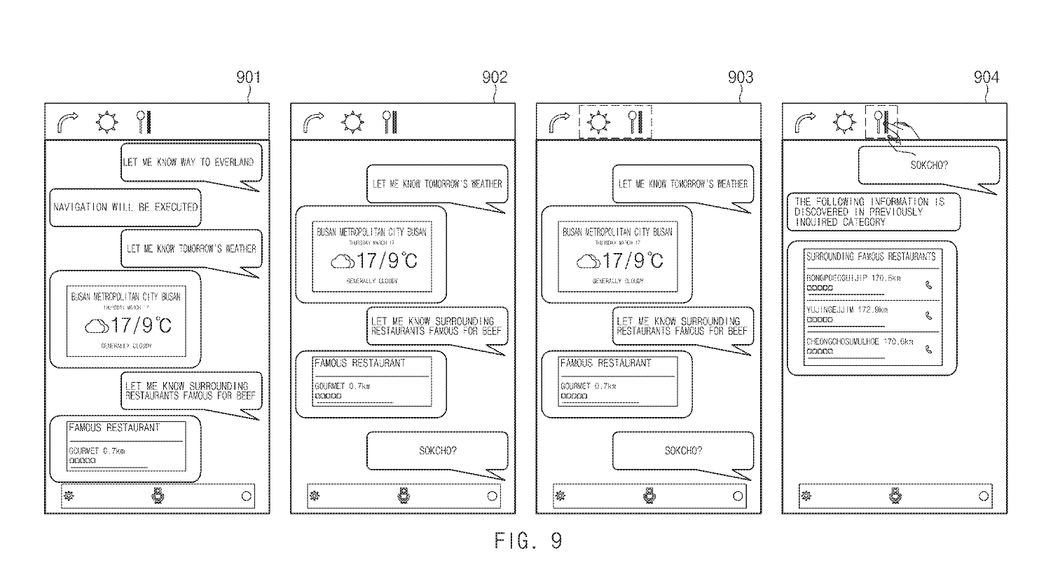

Hereinafter, user interfaces according to the embodiments will be described in greater detail with reference to FIGS. 8 and 9.

Since display contents on a user interface displayed on a screen 801 of FIG. 8 are identical to the display contents on the screen 501 of FIG. 5 and display contents on screens 802 and 803 of FIG. 8 are identical to the display contents on the screen 502 of FIG. 5, descriptions thereof will not be repeated.

The screen 801 of FIG. 8 may further include contents (e.g., icons) displayed thereon, compared with the screen 501 of FIG. 5, in which the contents are linked to domains that match a second user input and one or more third user inputs.

Furthermore, although FIG. 8 illustrates that the contents of the screens 801 to 803, which are linked to the domains, are displayed on an upper side of a dialog window, the contents may be displayed on a separate pop-up window, on a lower side of the dialog window, or in a speech bubble. For the convenience of description, domain information may be displayed in an icon form on the screens 801 to 803 of FIG. 8. Here, the icons may correspond to “navigation”, “weather”, and “famous restaurant” domains, respectively, in a serial order from the left.

On the screen 802, a user interface may obtain a first user input (e.g., “Sokcho”) that is a user's current speech. The electronic device 100 may display a speech recognition result of the user's first user input on the screen 802. For example, the electronic device 100 may display the current speech “Sokcho” as a text “Sokcho” that the user is to recognize.

Referring to the screen 803, the electronic device 100 may activate icons linked to domains matching the first user input. Referring to the description of FIG. 4, the matched domains may include a second domain and at least one third domain. For example, the electronic device 100 may activate both an icon linked to “weather” and an icon linked to “famous restaurant” based on the determination that the user input matches both “weather” and “famous restaurant” domains.

On a screen 804 of FIG. 8, the electronic device 100 may further include application execution results associated with the matched domains. The display of the application execution results may refer to the description of the screen 503 of FIG. 5. For example, for the “weather” and “famous restaurant” domains, the electronic device 100 may display all execution results of a weather application and a famous-restaurant application that are associated with the “weather” domain and the “famous restaurant” domain. The execution results of the respective applications may be displayed in an abridged form. In the case where the user selects the corresponding results, the user interface may display corresponding application screens or may display specific information.

Screens 901 to 904 of FIG. 9 may provide user interfaces by which to obtain a user's selection of a specific icon and display an execution result of an operation for a linked domain. Since the screens 901 to 903 are identical to the screens 801 to 803 of FIG. 8, repetitive descriptions thereof will not be repeated.

Unlike the icons of FIG. 8, icons on the screens 903 and 904 of FIG. 9 may be selected by the user. The electronic device 100 may obtain the user's selection of a specific icon. The selection may include a touch, a double tap, a force touch, or the like on the icon through a touch screen.

On the screen 904 of FIG. 9, the electronic device 100 may output an application execution result associated with the selected domain on a dialog window. For example, in the case where the user selects an icon linked to a famous-restaurant domain, the electronic device 100 may output an execution result of an application linked to the famous-restaurant domain in response to the selection.

Although not illustrated in FIG. 9, the electronic device 100 may obtain a selection of an additional icon (e.g., a weather icon on the screen 904). In response to the selection, the electronic device 100 may additionally output an execution result of an application associated with a weather domain.

The electronic device 100 may output a guidance text (e.g., “Search results for the selected category are as follows”) prior to the application execution result.

In various embodiments, the application execution result may be generated for all matched domains before the selection of the domain, or may be generated for only the domain selected by the user.

Meanwhile, the present disclosure proposes another method of processing various inputs for user convenience. Hereinafter, a method of obtaining a user's selection of an existing dialog history and using domain and slot information corresponding to the selected history is proposed.

In the case where the user selects contents (e.g., a text, a speech bubble, an icon, or the like) associated with previous speech contents and enters, through a speech or gesture, an input classified as a part of a slot, intent, or a domain, the electronic device 100 or the server 1000 may provide an appropriate response to the user in consideration of a slot, intent, and/or a domain corresponding to the previous speech contents.

For example, in the case where the previous speech includes “Let me know tomorrow's weather” and “Find a way to Mt. Kumgang”, the user may utter “weather the day after tomorrow” after selecting the sentence “Let me know tomorrow's weather” if the user wants to know information about the weather the day after tomorrow. In response to this, the electronic device 100 may obtain information about the weather the day after tomorrow. If the user wants information about a way to the Blue House, the user may select “Find a way to Mt. Kumgang” and may utter “Blue House”. The electronic device 100 may provide information about a way to the Blue House on the basis of a combination of the selected speech (domain) and the user input (current speech).

For the above-described operations, the electronic device 100 may separately display the previous speech contents on the screen. The electronic device 100 and/or the server 1000 may have, in advance, a plurality of pieces of information about previous speeches (e.g., domains, intents, and slots) that are classified according to contents (e.g., a text, a word, an icon, or the like). The contents and the plurality of pieces of information corresponding to the domains, slots, and/or intents may be linked together. Meanwhile, in the case where the contents are icons, the contents may be linked to only the domains.

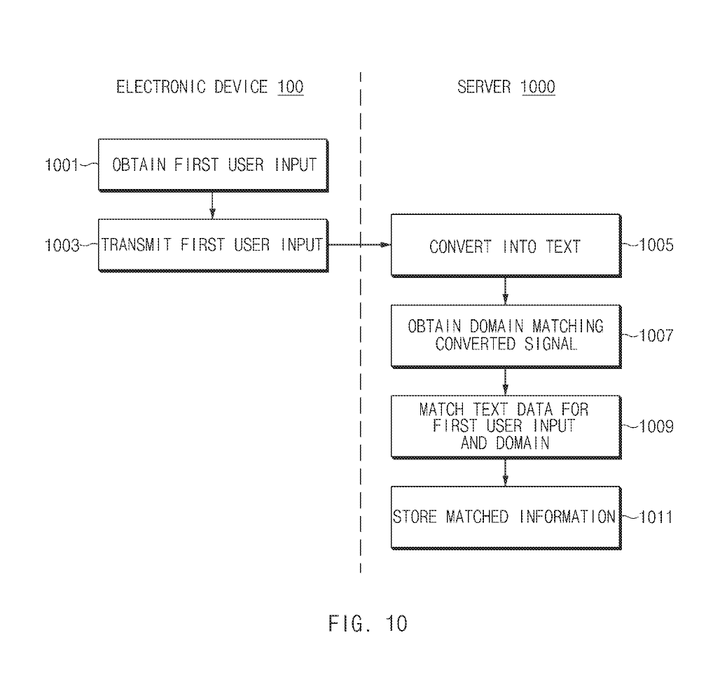

FIG. 10 is a flowchart illustrating an example method of processing various inputs, according to another example embodiment of the present disclosure. A method of matching a user input with domain information and storing the matched information will be described below with reference to FIG. 10.

Hereinafter, operations of the electronic device 100 and the server 1000 for a current user input (hereinafter, referred to as a first user input) will be described.

Since operations 1001 to 1005 are identical to operations 701 to 705 of FIG. 7, descriptions thereof will not be repeated.

In operation 1007, the server 1000 may obtain a domain matching a converted signal. As described above, this operation may be performed by the NLU unit 242 and/or the DM 244. Embodiments of the present disclosure may be applied to obtain the domain. According to an embodiment, the electronic device 100 may obtain the domain for the user input on the basis of the operations of FIG. 4 or 7. According to another embodiment, the electronic device 100 may obtain the domain as a natural language understanding result in the case where information sufficient to determine intent is entered.

In operation 1009, the server 1000 may match text data for the first user input and the domain. In operation 1011, the server 1000 may store the matched information. The server 1000 may combine the domain and an index for the user input and may store the domain information combined with the index for the user input. The server 1000 may additionally store slot information associated with the domain information. The slot information may also be associated with the index for the user input. The matched information may be stored in the domain DB management unit 284. The server 1000 may access the domain DB management unit 284 to extract the corresponding information according to necessity. Here, the matched information may include the text data, the domain, and a relationship between the text data and the domain information.

While the operations in FIG. 10 have been described as being performed by the server 1000 and the electronic device 100, the operations may be performed by only the electronic device 100 as described above. In another embodiment, some operations of the server 1000 may be performed by the electronic device 100, and some operations of the electronic device 100 may be performed by the server 1000.

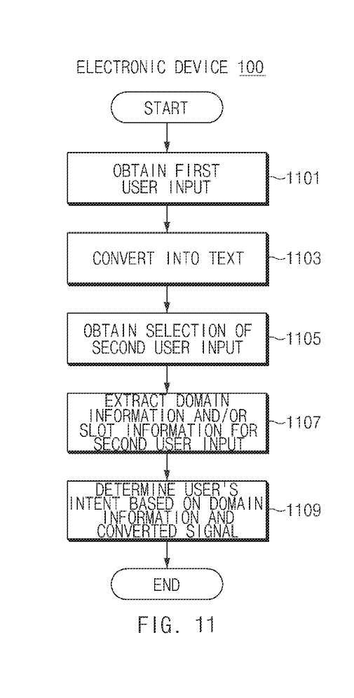

FIG. 11 is a flowchart illustrating an example method of processing various inputs, according to another example embodiment of the present disclosure. A method of extracting a domain from a previous speech and matching and storing text data corresponding to contents (a sentence, a word, an icon, or the like) of the previous speech will be described below with reference to FIG. 11.

Hereinafter, operations of the electronic device 100 and the server 1000 for a current user input (hereinafter, referred to as a first user input) will be described. In an embodiment of the present disclosure, it is assumed that there are one or more second user inputs prior to the first user input, which is the current user input. In an embodiment of the present disclosure, it is assumed that the corresponding user inputs are displayed on a screen.

Since operations 1101 and 1103 are identical to operations 701 to 705 of FIG. 7, descriptions thereof will not be repeated.

In operation 1105, the electronic device 100 may obtain a user's selection of a specific second user input among the second user inputs. The electronic device 100 may determine whether there is a user selection, depending on whether there is a gesture corresponding to an additional user selection. For example, the electronic device 100 may determine whether there is a user selection, depending on whether the user performs a force touch or a double tap on a sentence (or speech bubble) or a word displayed on a user interface. Here, operation 1105 may be performed before or after operation 1101, or may be simultaneously performed together with operation 1101.

In operation 1107, the electronic device 100 may extract domain information for the specific second user input. As described above, domain information and/or slot information may have been stored in advance for each second user input. In an embodiment, the domain and/or slot information for each second user input may have been stored in the domain DB management unit 284.

In operation 1109, the electronic device 100 may determine the user's intent based on the converted user input obtained in operation 1103 and the domain information obtained in operation 1107. For example, if the first user input is “Everland” and the domain information corresponding to the second user input is “weather”, the user's intent may be determined to be “weather search”. The server 1000 may substitute the first user input into a slot among the elements of the selected second user input. The slot of the second user input may have the same attribute as that of the first user input. For example, if the first user input includes a slot (e.g., Everland) corresponding to a place and the second user input includes a slot corresponding to a place, the server 1000 may substitute the first user input into the slot of the second user input.

Thereafter, the electronic device 100 may perform an operation associated with the received domain and/or intent information and may obtain a service execution result (e.g., an application execution result). Here, slot information obtained from the first user input may be additionally used to perform the operation.

While FIG. 11 illustrates that the slot information is extracted from the first user input and the domain information is extracted based on the selection of the second user input, the present disclosure may also be applied to the case where domain information is extracted from the first user input and slot information is extracted based on a selection of the second user input. In this case, operation 1109 may be replaced with an operation of extracting slot information for the second user input. In another embodiment, an operation of determining a domain from the converted signal may be performed after operation 1105.

In a modified embodiment, the electronic device 100 may perform an operation of determining whether the first user input corresponds to a domain or a slot, extracting slot information from the second user input in the case where the first user input corresponds to a domain, and extracting domain information from the second user input in the case where the first user input corresponds to a slot.

While the operations in FIG. 11 have been described as being performed by only the electronic device 100, the operations may also be performed by the server 1000. Some of the operations may be performed by the electronic device 100, and the other operations may be performed by the server 1000. For example, the electronic device 100 may transmit, to the server 100, the domain information obtained from the first user input and the converted information corresponding to the second user input.

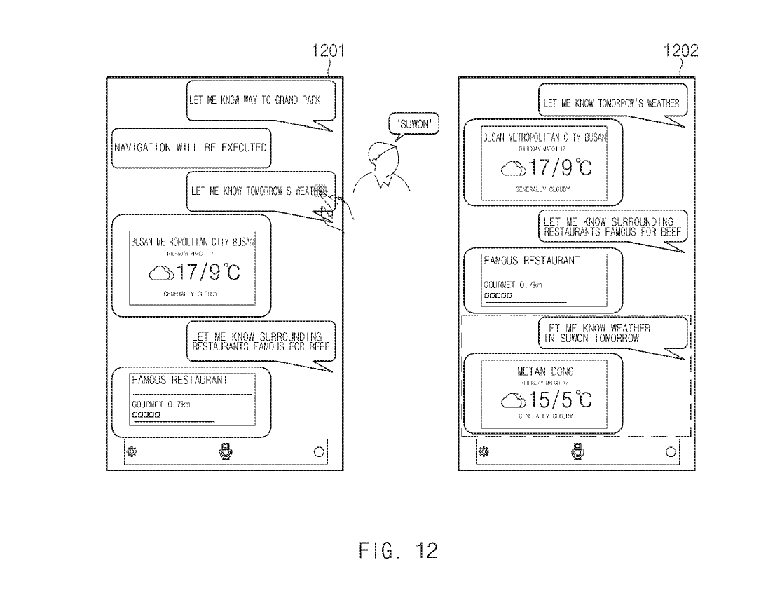

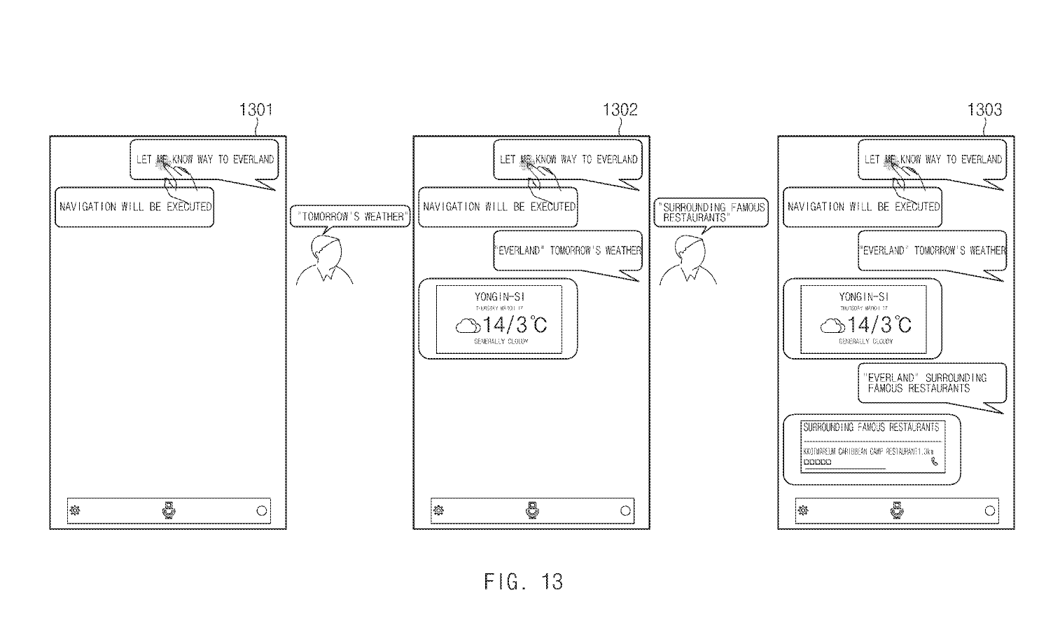

FIGS. 12 and 13 are diagrams illustrating example user interfaces according to various example embodiments.

In FIGS. 12 and 13, it is assumed that one or more second user inputs are displayed on a screen prior to a first user input.

A screen 1201 of FIG. 12 may provide a user interface representing previous dialog histories, and a screen 1202 may provide a user interface depending on a current speech according to an embodiment of the present disclosure.

According to the previous dialog histories, the electronic device 100 may display recognition results of the second user inputs by using a text. The recognition results may also be displayed in speech bubbles. The second user inputs may be displayed on the screen 1201 as recognition results of user speech inputs.

The electronic device 100 may obtain a user's selection of a specific text (or speech bubble) corresponding to any one of the second user inputs on the screen 1201. The electronic device 100 may additionally obtain the first user input from the user. The first user input may be received before or after the selection. The first user input may be received at the same time that the second user input is selected. Here, the operation of selecting the second user input may be referred to as a third user input. In the case where the user wants to use contents (e.g., a specific text, a speech bubble, a word, or an icon) displayed for the previous dialog histories, the user may perform a long press, a force touch, a double tap, or the like on the corresponding contents. In this case, speech not including repeated words may be performed.

In response to the selection of the second user input and the first user input corresponding to the user speech, the electronic device 100 may output a recognition result of the user inputs. Here, the recognition result of the user inputs may refer to a result that includes a speech recognition result of the first user input and user intent determined based on the selection of the second user input. For example, if the user selects “Let me know tomorrow's weather” among the second user inputs and utters “Everland” as the first user input, the electronic device 100 may display “Let me know the weather in Everland tomorrow” as a recognition result of the user inputs. As described above, the recognition result of the user inputs may include the first user input contents and a part of the second user input contents.

In response to the selection of the second user input and the first user input corresponding to the user speech, the electronic device 100 may display a service execution result.

For example, the user may select “Let me know tomorrow's weather” and may utter “Suwon”. In this case, the electronic device 100 may display, on the screen 1202, “Let me know the weather in Suwon tomorrow” as a recognition result of the input. Referring to the screen 1202, for the combination of “Let me know tomorrow's weather” and “Suwon”, the electronic device 100 may display, on the screen 1202, information about the weather in Suwon tomorrow. Here, the information about the weather in Suwon tomorrow may be an application execution result.

FIG. 13 is a diagram illustrating another example embodiment of a user interface according to various example embodiments of the present disclosure.

A screen 1301 may provide a user interface representing previous dialog histories, and screens 1302 and 1303 may provide user interfaces depending on current speeches according to an embodiment of the present disclosure.

A second user input corresponding to the previous dialog histories may be displayed with a text (a speech bubble or a sentence). The second user input may be displayed on the screen 1301 as a recognition result of a user speech input.

On the screen 1302, the electronic device 100 may recognize an operation of selecting, by a user, a specific word in a text corresponding to the second user input and may obtain an additional first user input. Here, the operation of selecting the specific word may be referred to as a third user input. The first user input may be of a user speech input form. The specific word may correspond to a slot, a domain, or intent.

For the following operations, a slot, a domain, or intent may be classified and stored for each element (e.g., word) of a text corresponding to a speech bubble.

On the screen 1302, the electronic device 100 may output a recognition result of the user inputs in response to the selection of the specific word and the first user input corresponding to the user speech. Here, the recognition result of the user inputs may refer to a result that includes a speech recognition result for the first user input and user intent determined based on the selection of the specific word. The recognition result of the user inputs may include the first user input contents and a part of the second user input contents.

On the screen 1303, the electronic device 100 may output a service execution result in response to the selection of the specific word and the first user input.

For example, the user may select “Everland” on the screen 1302 and may utter “surrounding famous restaurants”. In this case, the electronic device 100 may display, on the screen 1303, “famous restaurants around Everland” as a recognition result of the user inputs. For the combination of “Everland” and “surrounding famous restaurants”, the electronic device 100 may display, on the screen 1303, information about famous restaurants around Everland. Here, the information about famous restaurants around Everland may be an application execution result.

Meanwhile, the electronic device 100 and the server 1000 may be implemented to output a recognition result of user inputs by using two or more existing speeches and to output a service execution result for the user inputs.

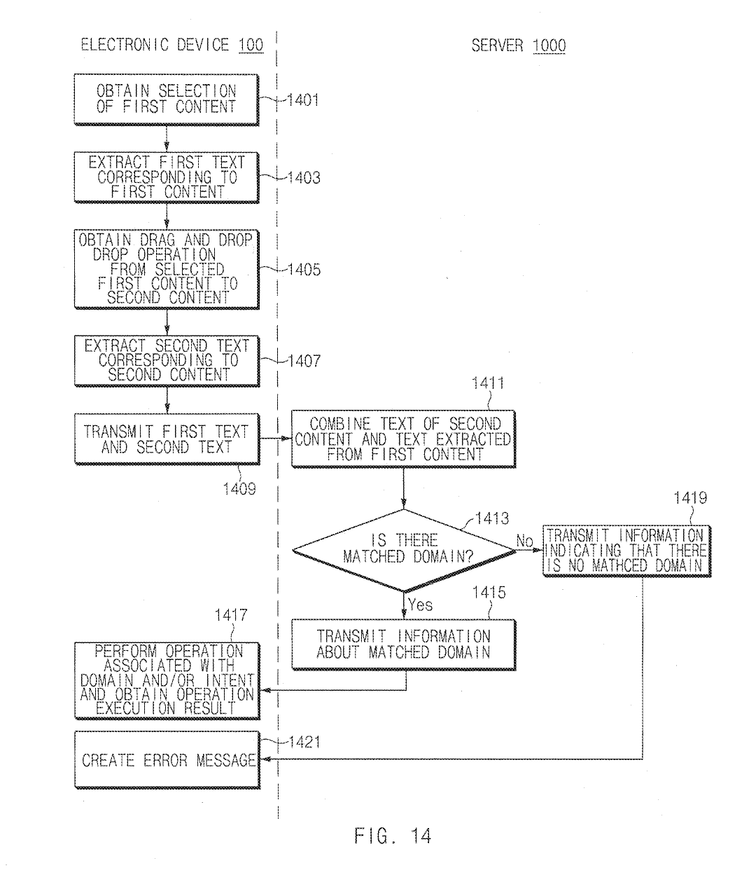

FIG. 14 is a flowchart illustrating an example method of processing various inputs, according to another example embodiment of the present disclosure. A method of determining user intent using two or more previous speeches and performing an operation according to the user intent in the electronic device 100 and the server 1000 will be described below with reference to FIG. 14.

Hereinafter, operations of the electronic device 100 and the server 1000 for a current user input (hereinafter, referred to as a first user input) will be described. In an embodiment of the present disclosure, it is assumed that there is at least one second user input prior to the first user input. In an embodiment of the present disclosure, it is assumed that the corresponding user input is displayed on a screen.

In operation 1401, the electronic device 100 may recognize and obtain a user's selection of content as a part of the first user input. Here, the selected content is referred to as a first content. The first content may be any one of a text, a word, or an icon corresponding to the second user input.

In operation 1403, the electronic device 100 may extract a first text corresponding to the first content. To this end, in an embodiment, a text may have been stored in units of a text for the second user input or a word in the text. In an embodiment, a text corresponding to an icon may have been stored. Intent, a domain, or a slot may have been matched in units of a sentence for the second user input or a word in the sentence. A domain may have been matched with an icon.

In operation 1405, the electronic device 100 may obtain a drag and drop operation from the selected first content to a second content as a part of the first user input. The second content may be any one of a text, a word, or an icon corresponding to the second user input.

In operation 1407, the electronic device 100 may extract a second text corresponding to the second content, and in operation 1409, the electronic device 100 may transmit the first text and the second text to the server 1000.

In operation 1411, the server 1000 may combine the first text and the second text. Here, the combination of the texts may correspond to substitution of the first text into the second text. For example, an operation of substituting the text extracted from the first content into the text of the second content may be performed as follows. In the case where the first content corresponds to a domain, the server 1000 may substitute the domain corresponding to the first content into a domain corresponding to the second content. In the case where the first content corresponds to a slot, the server 1000 may substitute the slot of the text of the first content into a slot corresponding to the second content.

Operation 1411 may also be applied to a case where any one of the first and second contents is an icon. For example, in the case where the second content is an icon and the first content is a text, the server 1000 may replace the domain of the first content with a domain linked to the icon.

In operation 1413, the server 1000 may determine whether a domain is matched according to the combination of the first text and the second text. Here, whether a domain is matched or not may be determined based on whether a slot matches the domain. Specifically, whether a domain is matched or not may be determined based on whether a slot having a relevant attribute is included in a sub-node of the domain. For example, referring to Table 1, in the case where a slot corresponds to a place, if a domain corresponds to navigation, the slot and the domain may match each other. However, if a slot corresponds to a place and a domain corresponds to music, the slot and the domain may not match each other.

If a domain and a slot match each other, the server 1000 may, in operation 1415, transmit the matched domain information, and the electronic device 100 may, in operation 1417, may obtain a service execution result by performing an operation associated with the domain and/or intent. As described above in conjunction with FIG. 4, the service execution result may be an application execution result associated with the domain.

Meanwhile, before obtaining the service execution result, the server 1000 may obtain a recognition result of the first user input. Here, the recognition result of the first user input may correspond to a result that includes user intent determined based on the combination of the first content and the second content. For example, if the first content corresponds to “Everland” and the second content corresponds to “What is the weather today?”, a user interface may display “What is the weather in Everland?” by combining the first content and the second content.

Meanwhile, in the case where a domain is not matched, in operation 1419, the server 1000 may transmit, to the electronic device 100, information indicating that there is no matched domain. In response to this, the electronic device 100 may, in operation 1421, create an error message to inform that the combination of the first content and the second content is not appropriate.

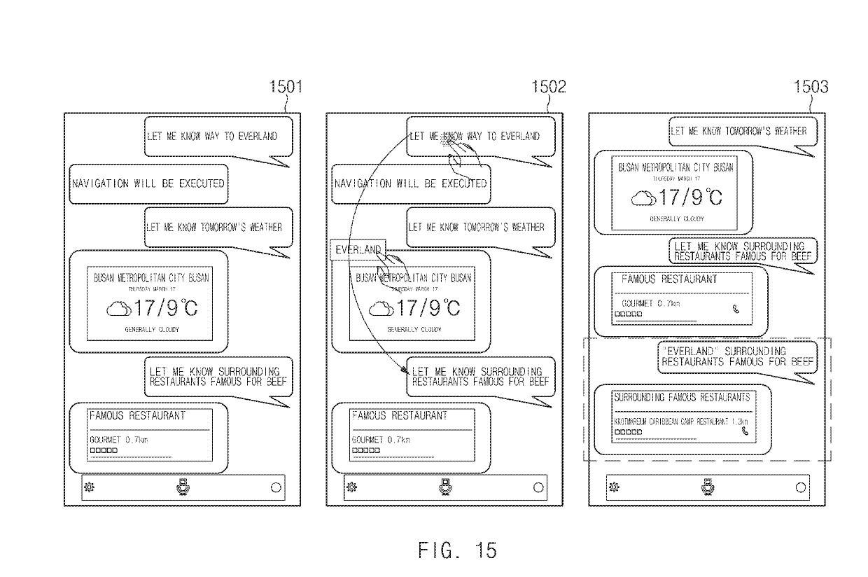

FIG. 15 is a diagram illustrating an example user interface in the case where two or more existing speeches are used, according to an example embodiment of the present disclosure.

A screen 1501 may provide a user interface including previous dialog histories, a screen 1502 may provide a user interface associated with a user input, and a screen 1503 may provide a user interface representing a response to a user operation according to an embodiment of the present disclosure.

Since the previous dialog histories displayed on the screen 1501 are identical to those displayed on the screen 801 of FIG. 8, detailed descriptions thereof will not be repeated.

Referring to the screen 1502, the electronic device 100 may obtain a selection of a first content. On the screen 1502, the first content corresponds to a specific word “Everland” included in the text “Let me know way to Everland.”

The electronic device 100 may obtain an operation of dragging and dropping the first content on a second content. On the screen 1502, the second content corresponds to the text “Let me know surrounding restaurants famous for beef.”

Here, the electronic device 100 may display the first content in a text form, which is visible to a user's naked eyes, in response to the selection of the first content to allow the user to clearly know the selected content. In an embodiment, the electronic device 100 may move the specific word on the screen 1502 along the path of the drag and drop operation. The selection of the first content and the drag and drop of the first content on the second content may be referred to as a first user input.

Referring to the screen 1503, the electronic device 100 may display a recognition result corresponding to the first user input. Here, the recognition result may include a part of the first content and a part of the second content.

Furthermore, the electronic device 100 may display an application execution result in response to the first user input.

For example, it is assumed that, on the screen 1502, the user selects the word “Everland” included in the first sentence and drags and drops “Everland” on the sentence or speech bubble “Let me know surrounding restaurants famous for beef.”

The electronic device 100 may display, on the screen 1503, “information about famous beef restaurants around Everland” as a recognition result for the selection and the drag and drop operation.

The electronic device 100 may display, on the screen 1503, an application execution result associated with famous restaurants in response to the selection of “Everland” and the drag and drop of “Everland” on “Let me know surrounding restaurants famous for beef.”

In the case of using an icon similar to that illustrated in FIG. 7, the user may select the icon and may drag and drop the corresponding icon on a specific text. For example, in the case where the user selects an icon associated with a famous-restaurant domain and then drags and drops the icon on the sentence “Let me know a way to Suwon”, the electronic device 100 may display information about famous restaurants in Suwon.

As described above, the method of processing speech recognition and the method of outputting a speech recognition result on a user interface may use previous domain information to accurately determine a user's intent, thereby reducing errors.

Furthermore, a user may simply utter only desired contents on the basis of a previous speech recognition result, and thus usability may be improved. In addition, a user may intuitively know how the user has to utter through a previous speech.

FIG. 16 is a diagram illustrating an example electronic device in a network environment, according to various example embodiments.

Referring to FIG. 16, according to various embodiments, an electronic device 1601, a first external electronic device 1602, a second external electronic device 1604, or a server 1606 may be connected with each other over a network 1662 or local wireless communication 1664. The electronic device 1601 may include a bus 1610, a processor (e.g., including processing circuitry) 1620, a memory 1630, an input/output interface (e.g., including input/output circuitry) 1650, a display 1660, and a communication interface (e.g., including communication circuitry) 1670. According to an embodiment, the electronic device 1601 may not include at least one of the above-described elements or may further include other element(s).

For example, the bus 1610 may interconnect the above-described elements 1620 to 1670 and may include a circuit for conveying communications (e.g., a control message and/or data) among the above-described elements.

The processor 1620 may include various processing circuitry, such as, for example, and without limitation, one or more of a dedicated processor, a central processing unit (CPU), an application processor (AP), or a communication processor (CP), or the like. For example, the processor 1620 may perform an arithmetic operation or data processing associated with control and/or communication of at least other elements of the electronic device 1601.

The memory 1630 may include a volatile and/or nonvolatile memory. For example, the memory 1630 may store instructions or data associated with at least one other element(s) of the electronic device 1601. According to an embodiment, the memory 1630 may store software and/or a program 1640. The program 1640 may include, for example, a kernel 1641, a middleware 1643, an application programming interface (API) 1645, and/or an application program (or “an application”) 1647. At least a part of the kernel 1641, the middleware 1643, or the API 1645 may be referred to as an “operating system (OS)”.

For example, the kernel 1641 may control or manage system resources (e.g., the bus 1610, the processor 1620, the memory 1630, and the like) that are used to execute operations or functions of other programs (e.g., the middleware 1643, the API 1645, and the application program 1647). Furthermore, the kernel 1641 may provide an interface that allows the middleware 1643, the API 1645, or the application program 1647 to access discrete elements of the electronic device 1601 so as to control or manage system resources.

The middleware 1643 may perform, for example, a mediation role such that the API 1645 or the application program 1647 communicates with the kernel 1641 to exchange data.

Furthermore, the middleware 1643 may process one or more task requests received from the application program 1647 according to a priority. For example, the middleware 1643 may assign the priority, which makes it possible to use a system resource (e.g., the bus 1610, the processor 1620, the memory 1630, or the like) of the electronic device 1601, to at least one of the application program 1647. For example, the middleware 1643 may process the one or more task requests according to the priority assigned to the at least one, which makes it possible to perform scheduling or load balancing on the one or more task requests.

The API 1645 may be, for example, an interface through which the application program 1647 controls a function provided by the kernel 1641 or the middleware 1643, and may include, for example, at least one interface or function (e.g., an instruction) for a file control, a window control, image processing, a character control, or the like.

The input/output interface 1650 may include various input/output circuitry and play a role, for example, an interface which transmits an instruction or data input from a user or another external device, to other element(s) of the electronic device 1601. Furthermore, the input/output interface 1650 may output an instruction or data, received from other element(s) of the electronic device 1601, to a user or another external device.

The display 1660 may include, for example, a liquid crystal display (LCD), a light-emitting diode (LED) display, an organic LED (OLED) display, a microelectromechanical systems (MEMS) display, or an electronic paper display, or the like, but is not limited thereto. The display 1660 may display, for example, various contents (e.g., a text, an image, a video, an icon, a symbol, and the like) to a user. The display 1660 may include a touch screen and may receive, for example, a touch, gesture, proximity, or hovering input using an electronic pen or a part of a user's body.

For example, the communication interface 1670 may establish communication between the electronic device 1601 and an external device (e.g., the first electronic device 1602, the second electronic device 1604, or the server 1606). For example, the communication interface 1670 may be connected to the network 1662 over wireless communication or wired communication to communicate with the external device (e.g., the second electronic device 1604 or the server 1606).

The wireless communication may use at least one of, for example, long-term evolution (LTE), LTE Advanced (LIE-A), Code Division Multiple Access (CDMA), Wideband CDMA (WCDMA), Universal Mobile Telecommunications System (UMTS), Wireless Broadband (WiBro), Global System for Mobile Communications (GSM), or the like, as cellular communication protocol. Furthermore, the wireless communication may include, for example, the local wireless communication 1664. The local wireless communication 1664 may include at least one of wireless fidelity (Wi-Fi), Bluetooth, near field communication (NFC), magnetic stripe transmission (MST), a global navigation satellite system (GNSS), or the like.

The MST may generate a pulse in response to transmission data using an electromagnetic signal, and the pulse may generate a magnetic field signal. The electronic device 1601 may transfer the magnetic field signal to point of sale (POS), and the POS may detect the magnetic field signal using a MST reader. The POS may recover the data by converting the detected magnetic field signal to an electrical signal.

The GNSS may include at least one of, for example, a global positioning system (GPS), a global navigation satellite system (Glonass), a Beidou navigation satellite system (hereinafter referred to as “Beidou”), or an European global satellite-based navigation system (hereinafter referred to as “Galileo”) based on an available region, a bandwidth, or the like. Hereinafter, in this disclosure, “GPS” and “GNSS” may be interchangeably used. The wired communication may include at least one of, for example, a universal serial bus (USB), a high definition multimedia interface (HDMI), a recommended standard-232 (RS-232), a plain old telephone service (POTS), or the like. The network 1662 may include at least one of telecommunications networks, for example, a computer network (e.g., LAN or WAN), an Internet, or a telephone network.

Each of the first and second electronic devices 1602 and 1604 may be a device of which the type is different from or the same as that of the electronic device 1601. According to an embodiment, the server 1606 may include a group of one or more servers. According to various embodiments, all or a portion of operations that the electronic device 1601 will perform may be executed by another or plural electronic devices (e.g., the first electronic device 1602, the second electronic device 1604 or the server 1606). According to an embodiment, in the case where the electronic device 1601 executes any function or service automatically or in response to a request, the electronic device 1601 may not perform the function or the service internally, but, alternatively additionally, it may request at least a portion of a function associated with the electronic device 1601 at other electronic device (e.g., the electronic device 1602 or 1604 or the server 1606). The other electronic device may execute the requested function or additional function and may transmit the execution result to the electronic device 1601. The electronic device 1601 may provide the requested function or service using the received result or may additionally process the received result to provide the requested function or service. To this end, for example, cloud computing, distributed computing, or client-server computing may be used.

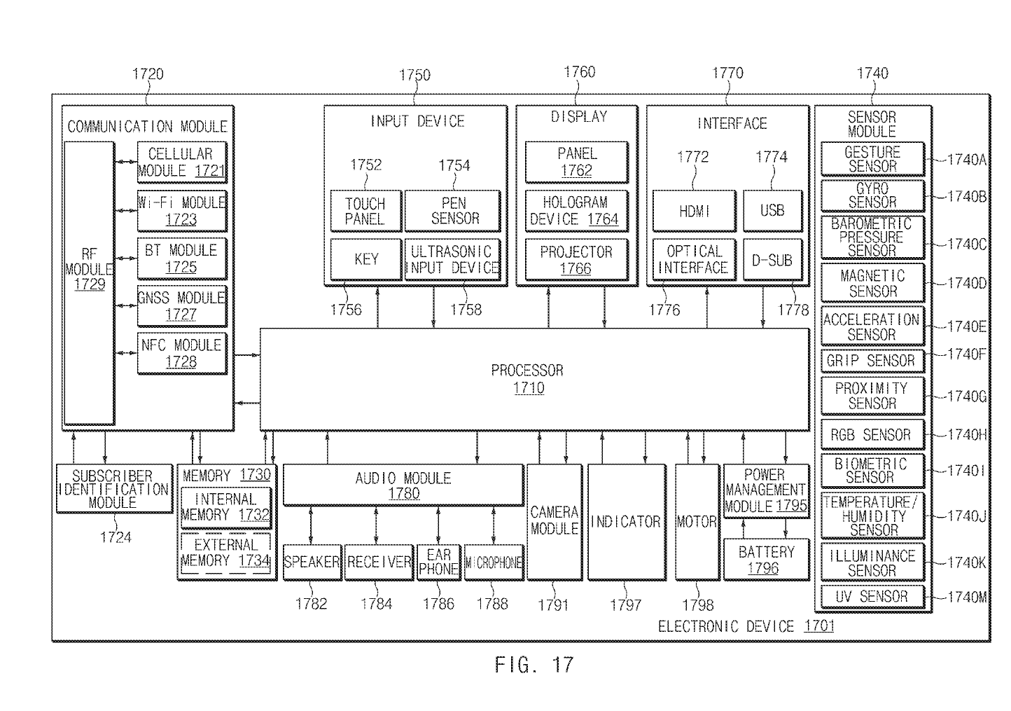

FIG. 17 is a block diagram illustrating an example electronic device, according to various example embodiments.

Referring to FIG. 17, an electronic device 1701 may include, for example, all or a part of the electronic device 1601 illustrated in FIG. 16. The electronic device 1701 may include one or more processors (e.g., an application processor (AP)) (e.g., including processing circuitry) 1710, a communication module (e.g., including communication circuitry) 1720, a subscriber identification module 1729, a memory 1730, a sensor module 1740, an input device (e.g., including input circuitry) 1750, a display 1760, an interface (e.g., including interface circuitry) 1770, an audio module 1780, a camera module 1791, a power management module 1795, a battery 1796, an indicator 1797, and a motor 1798.

The processor 1710 may include various processing circuitry and drive, for example, an operating system (OS) or an application to control a plurality of hardware or software elements connected to the processor 1710 and may process and compute a variety of data. For example, the processor 1710 may be implemented with a System on Chip (SoC). According to an embodiment, the processor 1710 may further include a graphic processing unit (GPU) and/or an image signal processor. The processor 1710 may include at least a part (e.g., a cellular module 1721) of elements illustrated in FIG. 17. The processor 1710 may load an instruction or data, which is received from at least one of other elements (e.g., a nonvolatile memory), into a volatile memory and process the loaded instruction or data. The processor 1710 may store a variety of data in the nonvolatile memory.

The communication module 1720 may be configured the same as or similar to the communication interface 1670 of FIG. 16. The communication module 1720 may include various communication circuitry, such as, for example, and without limitation, one or more of the cellular module 1721, a Wi-Fi module 1723, a Bluetooth (BT) module 1725, a GNSS module 1727 (e.g., a GPS module, a Glonass module, a Beidou module, or a Galileo module), a near field communication (NFC) module 1728, and a radio frequency (RF) module 1729.

The cellular module 1721 may provide, for example, voice communication, video communication, a character service, an Internet service, or the like over a communication network. According to an embodiment, the cellular module 1721 may perform discrimination and authentication of the electronic device 1701 within a communication network by using the subscriber identification module (e.g., a SIM card) 1724. According to an embodiment, the cellular module 1721 may perform at least a portion of functions that the processor 1710 provides. According to an embodiment, the cellular module 1721 may include a communication processor (CP).

Each of the Wi-Fi module 1723, the BT module 1725, the GNSS module 1727, or the NFC module 1725 may include a processor for processing data exchanged through a corresponding module, for example. According to an embodiment, at least a part (e.g., two or more) of the cellular module 1721, the Wi-Fi module 1723, the BT module 1725, the GNSS module 1727, or the NFC module 1728 may be included within one Integrated Circuit (IC) or an IC package.

For example, the RF module 1729 may transmit and receive a communication signal (e.g., an RF signal). For example, the RF module 1729 may include a transceiver, a power amplifier module (PAM), a frequency filter, a low noise amplifier (LNA), an antenna, or the like. According to another embodiment, at least one of the cellular module 1721, the Wi-Fi module 1723, the BT module 1725, the GNSS module 1727, or the NFC module 1728 may transmit and receive an RF signal through a separate RF module.

The subscriber identification module 1724 may include, for example, a card and/or embedded SIM that includes a subscriber identification module and may include unique identity information (e.g., integrated circuit card identifier (ICCID)) or subscriber information (e.g., international mobile subscriber identity (IMSI)).

The memory 1730 (e.g., the memory 1630) may include an internal memory 1732 and/or an external memory 1734. For example, the internal memory 1732 may include at least one of a volatile memory (e.g., a dynamic random access memory (DRAM), a static RAM (SRAM), a synchronous DRAM (SDRAM), or the like), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory), or the like), a hard drive, or a solid state drive (SSD).

The external memory 1734 may further include a flash drive such as compact flash (CF), secure digital (SD), micro secure digital (Micro-SD), mini secure digital (Mini-SD), extreme digital (xD), a multimedia card (MMC), a memory stick, or the like. The external memory 1734 may be operatively and/or physically connected to the electronic device 1701 through various interfaces.

The sensor module 1740 may measure, for example, a physical quantity or may detect an operation state of the electronic device 1701. The sensor module 1740 may convert the measured or detected information to an electrical signal. For example, the sensor module 1740 may include at least one of a gesture sensor 1740A, a gyro sensor 1740B, a barometric pressure sensor 1740C, a magnetic sensor 1740D, an acceleration sensor 1740E, a grip sensor 1740F, the proximity sensor 1740G, a color sensor 1740H (e.g., red, green, blue (RGB) sensor), a biometric sensor 1740I, a temperature/humidity sensor 1740J, an illuminance sensor 1740K, or an UV sensor 1740M. Although not illustrated, additionally or generally, the sensor module 1740 may further include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 1740 may further include a control circuit for controlling at least one or more sensors included therein. According to an embodiment, the electronic device 1701 may further include a processor that is a part of the processor 1710 or independent of the processor 1710 and is configured to control the sensor module 1740. The processor may control the sensor module 1740 while the processor 1710 remains at a sleep state.

The input device 1750 may include various input circuitry, such as, for example, and without limitation, one or more of a touch panel 1752, a (digital) pen sensor 1754, a key 1756, or an ultrasonic input device 1758. For example, the touch panel 1752 may use at least one of capacitive, resistive, infrared and ultrasonic detecting methods. Also, the touch panel 1752 may further include a control circuit. The touch panel 1752 may further include a tactile layer to provide a tactile reaction to a user.

The (digital) pen sensor 1754 may be, for example, a part of a touch panel or may include an additional sheet for recognition. The key 1756 may include, for example, a physical button, an optical key, or a keypad. The ultrasonic input device 1758 may detect (or sense) an ultrasonic signal, which is generated from an input device, through a microphone (e.g., a microphone 1788) and may check data corresponding to the detected ultrasonic signal.

The display 1760 (e.g., the display 1660) may include a panel 1762, a hologram device 1764, or a projector 1766. The panel 1762 may be the same as or similar to the display 1660 illustrated in FIG. 16. The panel 1762 may be implemented, for example, to be flexible, transparent or wearable. The panel 1762 and the touch panel 1752 may be integrated into a single module. The hologram device 1764 may display a stereoscopic image in a space using a light interference phenomenon. The projector 1766 may project light onto a screen so as to display an image. For example, the screen may be arranged in the inside or the outside of the electronic device 1701. According to an embodiment, the display 1760 may further include a control circuit for controlling the panel 1762, the hologram device 1764, or the projector 1766.

The interface 1770 may include various interface circuitry, such as, for example, and without limitation, one or more of a high-definition multimedia interface (HDMI) 1772, a universal serial bus (USB) 1774, an optical interface 1776, or a D-subminiature (D-sub) 1778. The interface 1770 may be included, for example, in the communication interface 1670 illustrated in FIG. 16. Additionally or generally, the interface 1770 may include, for example, a mobile high definition link (MHL) interface, a SD card/multi-media card (MMC) interface, or an infrared data association (IrDA) standard interface.

The audio module 1780 may convert a sound and an electric signal in dual directions. At least a part of the audio module 1780 may be included, for example, in the input/output interface 1650 illustrated in FIG. 16. The audio module 1780 may process, for example, sound information that is input or output through a speaker 1782, a receiver 1784, an earphone 1786, or the microphone 1788.

For example, the camera module 1791 may shoot a still image or a video. According to an embodiment, the camera module 1791 may include at least one or more image sensors (e.g., a front sensor or a rear sensor), a lens, an image signal processor (ISP), or a flash (e.g., an LED or a xenon lamp).

The power management module 1795 may manage, for example, power of the electronic device 1701. According to an embodiment, a power management integrated circuit (PMIC), a charger IC, or a battery or fuel gauge may be included in the power management module 1795. The PMIC may have a wired charging method and/or a wireless charging method. The wireless charging method may include, for example, a magnetic resonance method, a magnetic induction method or an electromagnetic method and may further include an additional circuit, for example, a coil loop, a resonant circuit, a rectifier, or the like. The battery gauge may measure, for example, a remaining capacity of the battery 1796 and a voltage, current or temperature thereof while the battery is charged. The battery 1796 may include, for example, a rechargeable battery and/or a solar battery.

The indicator 1797 may display a specific state of the electronic device 1701 or a part thereof (e.g., the processor 1710), such as a booting state, a message state, a charging state, and the like. The motor 1798 may convert an electrical signal into a mechanical vibration and may generate the following effects: vibration, haptic, and the like. Although not illustrated, a processing device (e.g., a GPU) for supporting a mobile TV may be included in the electronic device 1701. The processing device for supporting the mobile TV may process media data according to the standards of digital multimedia broadcasting (DMB), digital video broadcasting (DVB), MediaFLO™, or the like.

Each of the above-mentioned elements of the electronic device according to various embodiments of the present disclosure may be configured with one or more components, and the names of the elements may be changed according to the type of the electronic device. In various embodiments, the electronic device may include at least one of the above-mentioned elements, and some elements may be omitted or other additional elements may be added. Furthermore, some of the elements of the electronic device according to various embodiments may be combined with each other so as to form one entity, so that the functions of the elements may be performed in the same manner as before the combination.

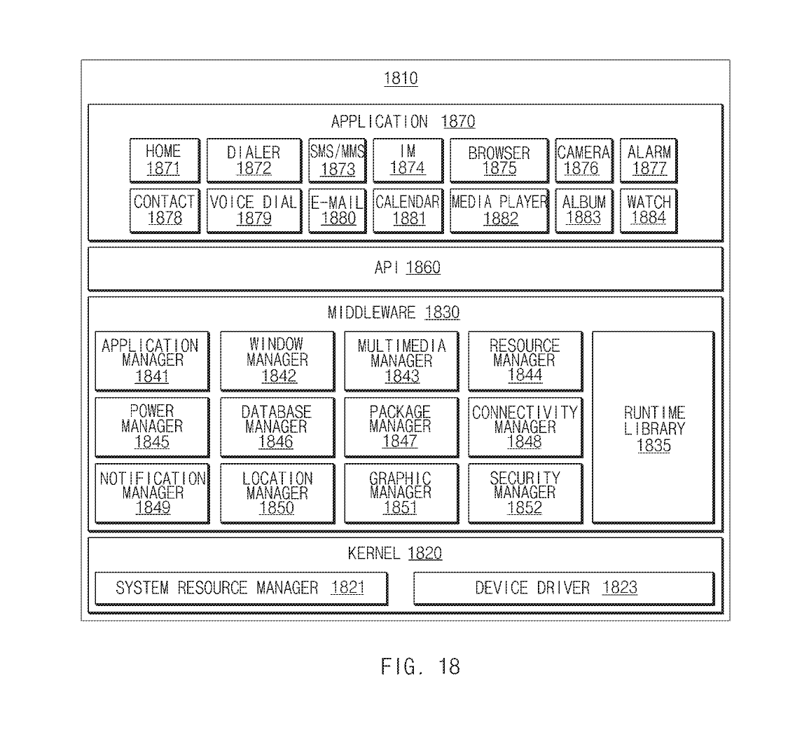

FIG. 18 is a block diagram illustrating an example program module, according to various example embodiments.

According to an embodiment, a program module 1810 (e.g., the program 1640) may include an operating system (OS) to control resources associated with an electronic device (e.g., the electronic device 1601), and/or diverse applications (e.g., the application program 1647) driven on the OS. The OS may be, for example, Android, iOS, Windows, Symbian, or Tizen.

The program module 1810 may include a kernel 1820, a middleware 1830, an application programming interface (API) 1860, and/or an application 1870. At least a portion of the program module 1810 may be preloaded on an electronic device or may be downloadable from an external electronic device (e.g., the first electronic device 1602, the second electronic device 1604, the server 1606, or the like).

The kernel 1820 (e.g., the kernel 1641) may include, for example, a system resource manager 1821 and/or a device driver 1823. The system resource manager 1821 may control, allocate, or retrieve system resources. According to an embodiment, the system resource manager 1821 may include a process managing unit, a memory managing unit, a file system managing unit, or the like. The device driver 1823 may include, for example, a display driver, a camera driver, a Bluetooth driver, a shared memory driver, a USB driver, a keypad driver, a Wi-Fi driver, an audio driver, or an inter-process communication (IPC) driver.

The middleware 1830 may provide, for example, a function that the application 1870 needs in common, or may provide diverse functions to the application 1870 through the API 1860 to allow the application 1870 to efficiently use limited system resources of the electronic device. According to an embodiment, the middleware 1830 (e.g., the middleware 1643) may include at least one of a runtime library 1835, an application manager 1841, a window manager 1842, a multimedia manager 1843, a resource manager 1844, a power manager 1845, a database manager 1846, a package manager 1847, a connectivity manager 1848, a notification manager 1849, a location manager 1850, a graphic manager 1851, and/or a security manager 1852.

The runtime library 1835 may include, for example, a library module that is used by a compiler to add a new function through a programming language while the application 1870 is being executed. The runtime library 1835 may perform input/output management, memory management, or capacities about arithmetic functions.

The application manager 1841 may manage, for example, a life cycle of at least one application of the application 1870. The window manager 1842 may manage a graphic user interface (GUI) resource that is used in a screen. The multimedia manager 1843 may identify a format necessary for playing diverse media files, and may perform encoding or decoding of media files by using a codec suitable for the format. The resource manager 1844 may manage resources such as a storage space, memory, or source code of at least one application of the application 1870.

The power manager 1845 may operate, for example, with a basic input/output system (BIOS) to manage a battery or power, and may provide power information for an operation of an electronic device. The database manager 1846 may generate, search for, or modify database that is to be used in at least one application of the application 1870. The package manager 1847 may install or update an application that is distributed in the form of package file.

The connectivity manager 1848 may manage, for example, wireless connection such as Wi-Fi or Bluetooth. The notification manager 1849 may display or notify an event such as arrival message, appointment, or proximity notification in a mode that does not disturb a user. The location manager 1850 may manage location information about an electronic device. The graphic manager 1851 may manage a graphic effect that is provided to a user, or manage a user interface relevant thereto. The security manager 1852 may provide a general security function necessary for system security, user authentication, or the like. According to an embodiment, in the case where an electronic device (e.g., the electronic device 1601) includes a telephony function, the middleware 1830 may further include a telephony manager for managing a voice or video call function of the electronic device.

The middleware 1830 may include a middleware module that combines diverse functions of the above-described elements. The middleware 1830 may provide a module specialized to each OS kind to provide differentiated functions. Additionally, the middleware 1830 may dynamically remove a part of the preexisting elements or may add new elements thereto.

The API 1860 (e.g., the API 1645) may be, for example, a set of programming functions and may be provided with a configuration that is variable depending on an OS. For example, in the case where an OS is the android or the iOS, it may provide one API set per platform. In the case where an OS is the tizen, it may provide two or more API sets per platform.

The application 1870 (e.g., the application program 1647) may include, for example, one or more applications capable of providing functions for a home 1871, a dialer 1872, an SMS/MMS 1873, an instant message (IM) 1874, a browser 1875, a camera 1876, an alarm 1877, a contact 1878, a voice dial 1879, an e-mail 1880, a calendar 1881, a media player 1882, an album 1883, and/or a watch 1884. Additionally, though not shown, the application 1870 may include applications related, for example, to health care (e.g., measuring an exercise quantity, blood sugar, or the like) or offering of environment information (e.g., information of barometric pressure, humidity, temperature, or the like).

According to an embodiment, the application 1870 may include an application (hereinafter referred to as “information exchanging application” for descriptive convenience) to support information exchange between an electronic device (e.g., the electronic device 1601) and an external electronic device (e.g., the first electronic device 1602 or the second electronic device 1604). The information exchanging application may include, for example, a notification relay application for transmitting specific information to an external electronic device, or a device management application for managing the external electronic device.

For example, the notification relay application may include a function of transmitting notification information, which arise from other applications (e.g., applications for SMS/MMS, e-mail, health care, or environmental information), to an external electronic device. Additionally, the notification relay application may receive, for example, notification information from an external electronic device and provide the notification information to a user.

The device management application may manage (e.g., install, delete, or update), for example, at least one function (e.g., turn-on/turn-off of an external electronic device itself (or a part of components) or adjustment of brightness (or resolution) of a display) of the external electronic device which communicates with the electronic device, an application running in the external electronic device, or a service (e.g., a call service, a message service, or the like) provided from the external electronic device.

According to an embodiment, the application 1870 may include an application (e.g., a health care application of a mobile medical device) that is assigned in accordance with an attribute of an external electronic device. According to an embodiment, the application 1870 may include an application that is received from an external electronic device (e.g., the first electronic device 1602, the second electronic device 1604, or the server 1606). According to an embodiment, the application 1870 may include a preloaded application or a third party application that is downloadable from a server. The names of elements of the program module 1810 according to the embodiment may be modifiable depending on kinds of operating systems.

According to various embodiments, at least a portion of the program module 1810 may be implemented by software, firmware, hardware, or a combination of two or more thereof. At least a portion of the program module 1810 may be implemented (e.g., executed), for example, by the processor (e.g., the processor 1710). At least a portion of the program module 1810 may include, for example, modules, programs, routines, sets of instructions, processes, or the like for performing one or more functions.

The term “module” used in this disclosure may refer, for example, to a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include, for example, and without limitation, at least one of a dedicated processor, a CPU, an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to various embodiments may be, for example, implemented by instructions stored in computer-readable storage media in the form of a program module. The instruction, when executed by a processor (e.g., the processor 120), may cause the one or more processors to perform a function corresponding to the instruction. The computer-readable storage media, for example, may be the memory 1630.

A computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), and hardware devices (e.g., a read only memory (ROM), a random access memory (RAM), or a flash memory). Also, a program instruction may include not only a mechanical code such as things generated by a compiler but also a high-level language code executable on a computer using an interpreter. The above hardware unit may be configured to operate via one or more software modules for performing an operation of various embodiments of the present disclosure, and vice versa.

A module or a program module according to various embodiments may include at least one of the above elements, or a part of the above elements may be omitted, or additional other elements may be further included. Operations performed by a module, a program module, or other elements according to various embodiments may be executed sequentially, in parallel, repeatedly, or in a heuristic method. In addition, some operations may be executed in different sequences or may be omitted. Alternatively, other operations may be added.

While the present disclosure has been illustrated and described with reference to various example embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a memory; and
at least one processor,
wherein the at least one processor is configured to:
obtain a first input;
determine first information based on the first input and a first domain matching the first input;
obtain a second input following the first input;
determine second information based on the second input and the first domain in response to the second input; and
determine third information based on the second input and a second domain different from the first domain.

2. The electronic device of claim 1, wherein the processor is configured to determine the third information based on the second domain based on an input history obtained prior to the first input.

3. The electronic device of claim 2, wherein the processor is configured to exclude a domain overlapping the first domain, from among domains corresponding to the input history, from the second domain.

4. The electronic device of claim 1, wherein the processor is configured to allow the first and second domains to be linked to a specific application.

5. The electronic device of claim 4, wherein the processor is configured to determine the first information, the second information, and the third information by obtaining service execution results linked to the respective domains.

6. The electronic device of claim 1, further comprising:
a microphone,
wherein at least one of the first and second inputs corresponds to a speech input obtained through the microphone.

7. The electronic device of claim 1, wherein the processor is configured to output the second information and the third information prior to an input following the second input.

8. A server comprising:
storage;
a communication circuit configured to receive a plurality of inputs from an electronic device; and
at least one processor,
wherein the at least one processor is configured to:
determine whether a first input, from among the plurality of inputs, matches a first domain;
determine whether the first input matches a second domain different from the first domain; and
transmit information about the first domain and information about the second domain to the electronic device, based on a matching determination with the first domain and second domain.

9. The server of claim 8, wherein the processor is configured to determine the first domain based on an input obtained right before the first input from among the plurality of inputs.

10. The server of claim 9, wherein the processor is configured to determine the first domain based on an input obtained before the first input from among the plurality of inputs.

11. The server of claim 8, wherein the processor is configured to determine the second domain based on an input obtained before the first input, from among the plurality of inputs, and the remaining inputs other than the first input.

12. The server of claim 11, wherein the processor is configured to perform speech recognition for the first input.

13. A method comprising:
obtaining a first input on an electronic device having a display;
outputting first information on the display in response to the first input;
obtaining a second input following the first input; and
outputting second information and third information on the display in response to the second input,
wherein the second information corresponds to a first domain matching the first input, and
wherein the third information corresponds to a second domain different from the first domain.

14. The method of claim 13, wherein a portion of the display includes an icon associated with the first information and the second information.

15. The method of claim 14, wherein a state of the icon changes in response to the second input.

16. The method of claim 13, wherein the second domain is determined based on an input history obtained prior to the first input.

17. The method of claim 16, further comprising:
obtaining a selection of the second information or the third information; and
outputting an application screen in response to the selection.

18. The method of claim 17, wherein the selection corresponds to a contact with a surface of the display.

19. The method of claim 13, wherein at least one of the first and second inputs corresponds to speech.

20. The method of claim 13, wherein the outputting of the second information and the third information includes sequentially displaying the second information and the third information.
